(19) United States
(12) Patent Application Publication
(10) Pub. No.: US 2025/0144844 A1
(43) Pub. Date: May 8, 2025

(54) PRESS AND METHOD OF USE

(71) Applicant: Plantd, Inc., Oxford, NC (US)

(72) Inventors: Huade Tan, Oxford, NC (US); Dillon Voss, Oxford, NC (US); Staton Michaels, Oxford, NC (US); Shek Lam Nicholas Poon, Oxford, NC (US)

(73) Assignee: Plantd, Inc., Oxford, NC (US)

(21) Appl. No.: 18/939,361

(22) Filed: Nov. 6, 2024

Related U.S. Application Data
(60) Provisional application No. 63/596,521, filed on Nov. 6, 2023.
(60) Provisional application No. 63/656,750, filed on Jun. 6, 2024.

(51) Int. Cl. B27N 3/24; B27N 3/20; B30B 15/00; B30B 15/04; B30B 15/16; B30B 15/30

(52) U.S. Cl. CPC B27N 3/24; B27N 3/206; B30B 15/0052; B30B 15/04; B30B 15/166; B30B 15/30

(57) ABSTRACT

In variants, the system can include a press frame, a set of conveyor systems, a set of core units, a set of pressure control systems, a power source, and/or any other suitable system components. The system components can cooperatively form a continuous press for manufacturing composite boards from composite board material by applying pressure and/or heat to the composite board material. In variants, the system can provide a modular, extensible, and lightweight continuous press that can be elongated or shortened by adding or removing modular core units to the core section.

### CROSS-REFERENCE TO RELATED APPLICATIONS

This application claims the benefit of U.S. Provisional Application No. 63/596,521, filed 6 Nov. 2023 and U.S. Provisional Application No. 63/656,750, filed 6 Jun. 2024, each of which is incorporated in its entirety by this reference.

### TECHNICAL FIELD

This invention relates generally to the engineered wood field, and more specifically to a new and useful manufacturing method in the engineered wood field.

### BRIEF DESCRIPTION OF THE FIGURES

FIG. 1 is a specific example of a variant of the system.

FIG. 2 is a specific example of a variant of a composite board.

FIG. 3 is an example of a variant of a material fragment coated with adhesive.

FIGS. 4A-4C are examples of variants of single-layer and two-layer boards with isotropically-oriented strands and anisotropically-oriented strands.

FIGS. 5A and 5B are examples of variants of conveyor systems.

FIG. 6 is an example of a variant of a system infeed and core unit.

FIGS. 7A and 7B are each an isometric view of a specific example of a variant of a platen and set of platens.

FIGS. 8A and 8B is a view of a specific example of a variant of a core segment.

FIGS. 9A and 9B are examples of a variant of a core segment frame viewed along with lengthwise and widthwise cross section, respectively.

FIGS. 10A and 10B are examples of a variant of a core unit in a pressing mode and a lifting mode, respectively, viewed along a widthwise cross section.

FIG. 11 is an example of a variant of heat flow.

FIG. 12 is an example of a variant of a release agent applicator.

FIG. 13 is an example of a variant of a pressure control system.

FIGS. 14A and 14B are schematic representations of variants of pressure control systems.

FIG. 15 is a schematic representation of the system within a variant of a composite board manufacturing process.

FIG. 16 is an example of a variant of the system.

FIG. 17A-17B are examples of variants of the press and infeed, respectively

FIG. 18A-18C are examples of variants of the longitudinal alignment element 410.

FIG. 19A-19B are examples of variants of the lateral alignment element 420.

FIG. 20A-20B are examples of variants of the belt conveyor displacement sensor.

FIG. 21 is an example of the platen lateral displacement sensor.

FIG. 22 is an example of platen vertical displacement sensors.

FIG. 23 is a longitudinal view of a variant of the composite mat in a variant of the press.

FIG. 24 is an illustrative example of differential sinistral and dextral pressing element control based on chain guide deflection.

FIG. 25 is an illustrative example of differential sinistral and dextral pressing element control based on platen lateral motion.

### DETAILED DESCRIPTION

The following description of the embodiments of the invention is not intended to limit the invention to these embodiments, but rather to enable any person skilled in the art to make and use this invention.

### 1. Overview

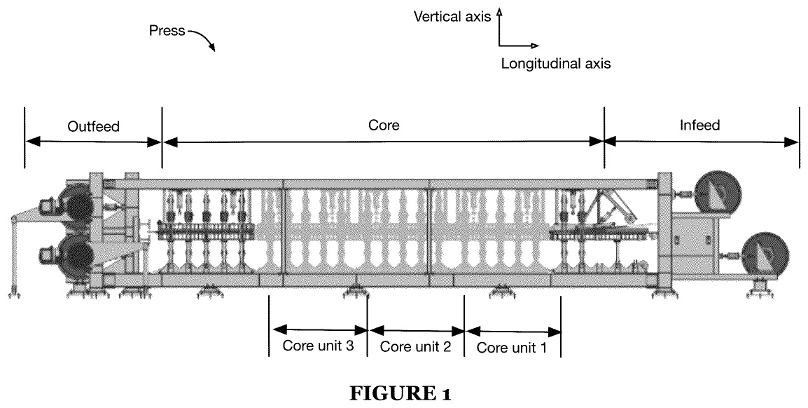

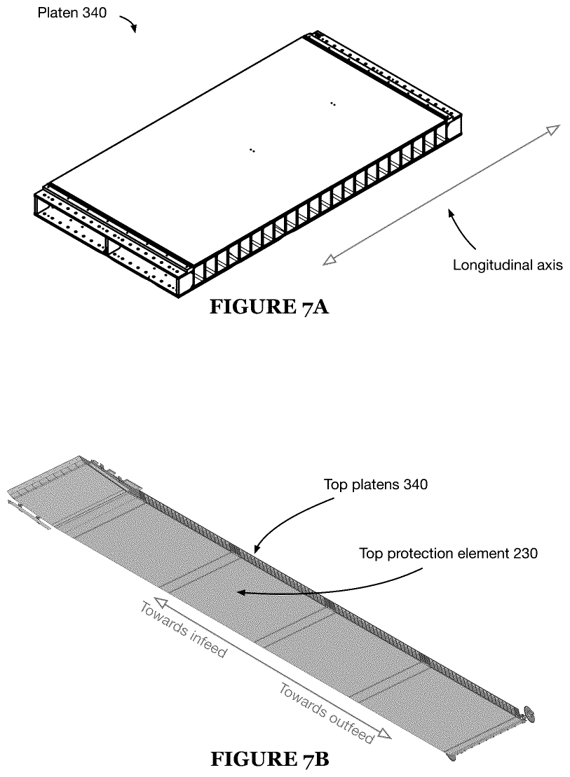

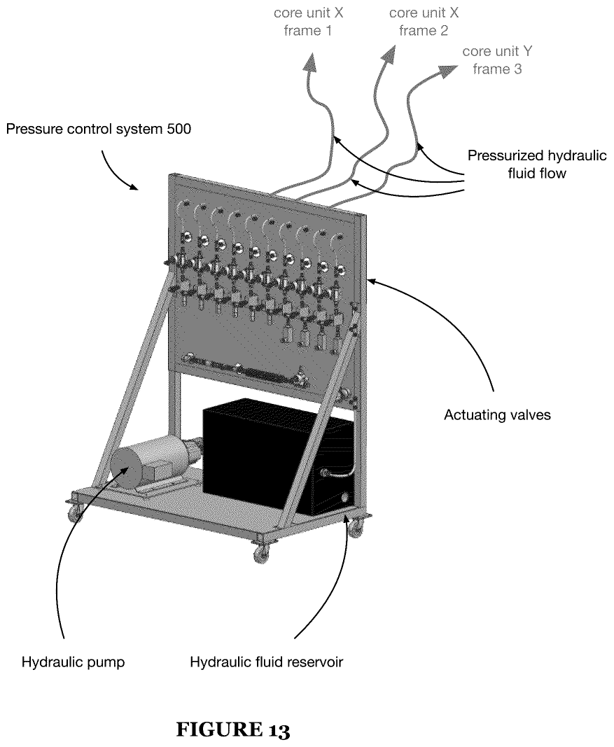

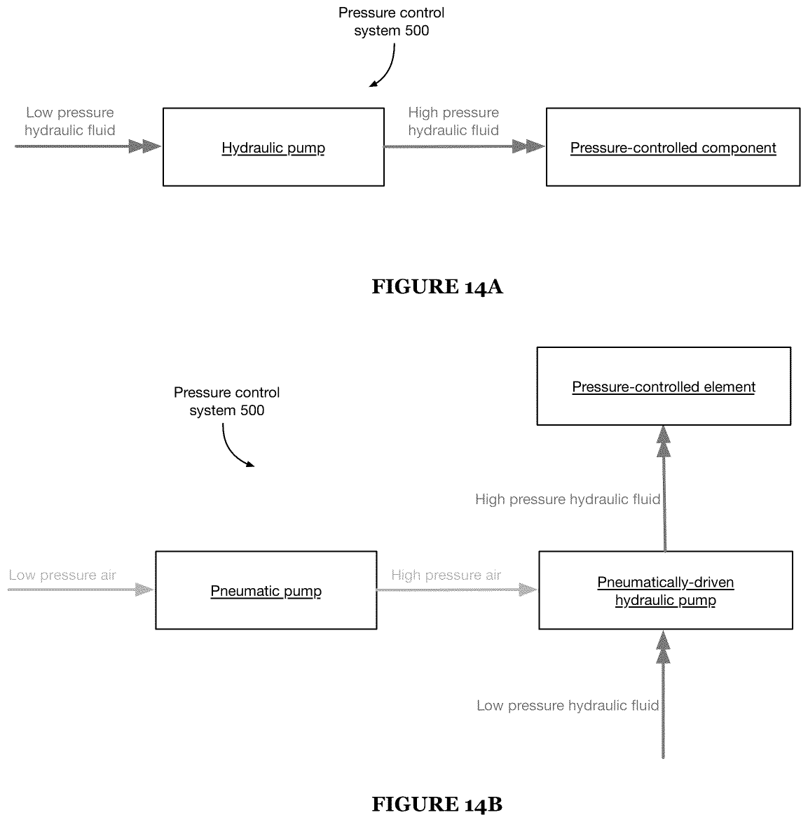

In variants, the system can include a press frame 100, a set of conveyor systems 200, a set of core units 300, a set of pressure control systems 500, a power source, and/or any other suitable system components (e.g., examples shown in FIG. 1, FIG. 6, FIG. 12, and FIG. 13). The system components can cooperatively form a machine (e.g., a continuous press, etc.) for manufacturing composite boards from composite board material by applying pressure and/or heat to the composite board material. In variants, the system can provide a modular, extensible, and lightweight continuous press that can be elongated or shortened by adding or removing modular core units 300 to the core section.

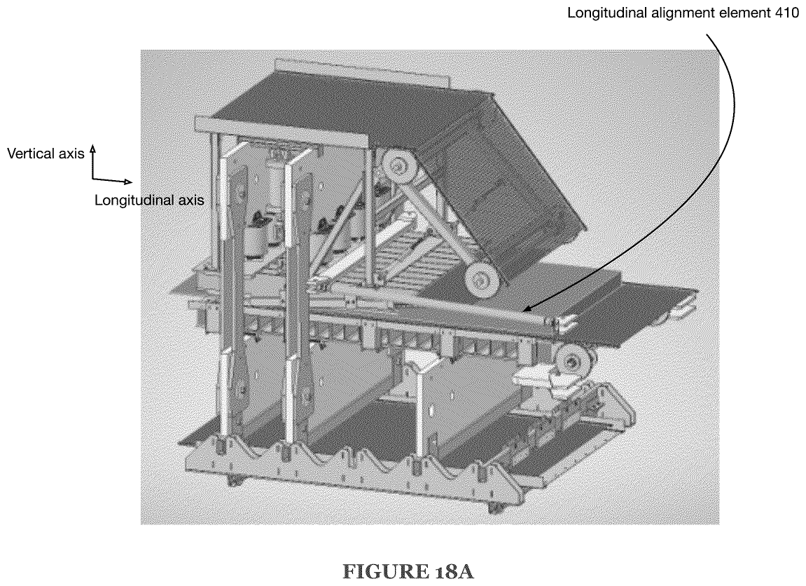

In an illustrative example, the system can include a press frame 100 supported by an adjustable set of feet; a set of pulleys driving a top belt 210 and a bottom belt 210 each controlled by a pair of tensioning elements; a set of modular core units 300 each including a set of pressing elements 320 and a set of heating elements 600 configured to mount to the press frame 100 and to pressurize and cure composite board material (e.g., example shown in FIG. 17A); a set of electrically-powered pressure control systems 500 configured to supply pressure (e.g., pressurized fluid) to at least the pressing elements 320 and tensioning elements; a set of longitudinal and lateral alignment elements; and an optional release agent applicator. In examples, the system can include: an infeed section, where the composite board material enters the press; a core section, where the composite board material is pressed into a predetermined thickness and optionally cured; an optional cooling section where the composite board material is cooled; and an outfeed section, where the composite board exits the press. In examples, the system can be mounted on a standard 6-inch concrete slab with no maintenance trench.

The alignment elements (e.g., longitudinal struts, lateral brackets, etc.) can constrain translational and/or rotational motion of top and bottom platens 340 relative to each other, and/or relative to the press frame, which can provide stiffness to the overall system (e.g., particularly a press formed from modular press elements). Additionally, alignment of system components and/or attributes of the composite board material can be measured by per-core unit sensor systems and corrected by per-core unit controls executed by system components (e.g., pressing elements 320, heating elements 600, etc.). For example, linear displacement sensors at sinistral and dextral portions of an outer face of a platen 340 can detect and measure platen roll and apply differential pressure to sinistral and dextral pressing elements 320 to correct the measured roll.

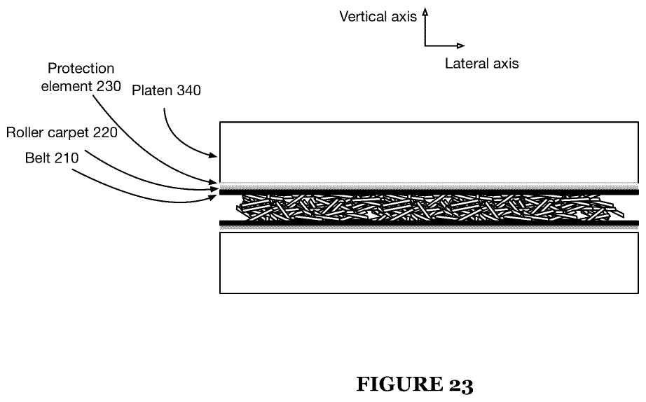

In examples, the set of core units 300 can be mounted to the press frame 100 and can apply a vertical pressure to the composite board material between two platens 340 (e.g., example shown in FIG. 23) statically or dynamically connected to a core unit frame 310. A dynamic connection between a platen 340 and core unit frame 310 can include pressing elements 320 (e.g., hydraulic pistons) which apply pressure to the platens 340, thus indirectly applying pressure to the composite board material. Additionally, in examples, each core unit 300 can include a lifting element 330 (e.g., a pneumatic piston) which lifts the top platen 340 when pressure is not needed (e.g., during press loading, inspection, etc.). Additionally, in examples, the set of core units 300 can include a set of heating elements 600 configured to heat the platens 340 as the composite board material travels between the platens 340, thus curing an adhesive within the composite board material to solidify the composite board material at a target thickness defined by the relative vertical positions of a top and bottom platen 340.

In examples, the number of the set of core units 300 can be increased or decreased in order to create a longer or shorter press. In examples, the belt 210 can be replaced or shortened to accommodate the new press length. In examples, the press frame 100 can include adjustable feet which can level the press frame 100 on an uneven floor, enabling the press to be installed, disassembled, and reinstalled on a variety of standard building surfaces (e.g., non-custom-built support surfaces).

However, the system can be otherwise configured.

### 2. Technical Advantages

Variants of the technology can confer one or more advantages over conventional technologies.

First, the usage of active and/or active alignment systems enable the usage of lightweight modules (e.g., core units 300). Examples of passive alignment systems can include longitudinal struts which prevent longitudinal platen motion, fixed connections between platens 340 enabling longitudinal inter-platen force transfer, lateral brackets directly laterally aligning platens 340 to each other (e.g., movably connecting platens 340 without an intervening pressing element 320, etc.). Such alignment systems can add stiffness to small and/or modular system components, enabling a press to achieve high pressures with small and/or modular parts which are easy to transport and use fewer raw materials.

Second, the system includes multiple features which enable easy in situ installation, without substantial site modification. Ease of installation enables the press to be maintained easily (e.g., by swapping out cure units, etc.), to be adjusted (e.g., by changing the length of the press, etc.), to be moved, and/or to be otherwise adjusted. Due to its modularity and small size, the system is lightweight and thus can be installed without a special foundation (e.g., a foundation with an integrated maintenance well). The system can include adjustable foot elements attached to the press frame 100, enabling the press to be installed on an uneven floor. The press's top conveyor system 200 and bottom conveyor system 200 can have infeed pulleys at different lengthwise positions, enabling replacement of the bottom conveyor system belt 210 without a maintenance well beneath the press. Additionally, the system can be electrically-powered, eliminating the need for a boiler and/or other heating equipment.

Third, the modularity enables the system to be easily set up, moved, and/or adjusted (e.g., lengthening or shortening the press by adding or removing modular core units 300). Additionally, modularity enables core units 300 and other components to be replaced quickly and easily, making repairs and testing of individual press components more facile.

Fourth, locating tensioning systems at both the infeed and the outfeed allow for widthwise belt position adjustment at both the infeed and outfeed, enabling the system to center the belt on the pulleys along the longitudinal axis. Such position adjustment can be useful since the modularity and/or lightweight nature of variants of the continuous press can result in slower feed and belt rates (e.g., 8 feet/minute, etc.), which may require continuous tracking abilities.

Fifth, the system is more energy-efficient than conventional press systems because it applies a lower pressure to the composite board material (e.g., 350 psi), and because it can run on electric power.

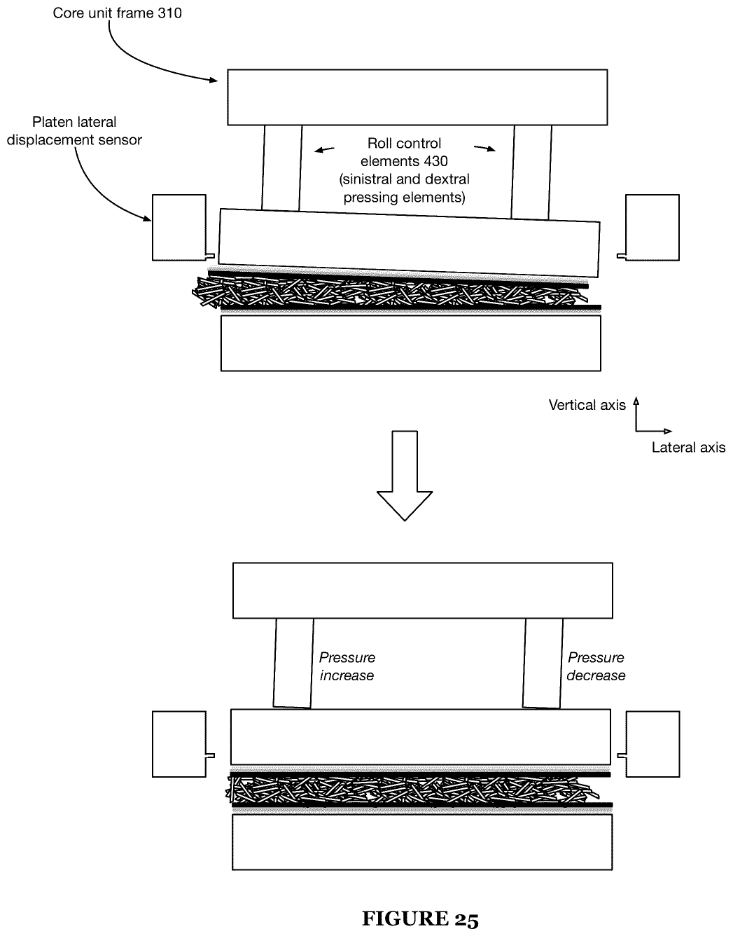

Sixth, module-specific (e.g., core unit-specific) and/or sub-module sensing and/or control enables the usage of differential longitudinal and/or lateral treatment (e.g., based on treatment profiles, etc.). For example, the press can apply heat to the composite board material differentially in a longitudinal direction, and/or the press can apply differential pressure to the board. Additionally, module-specific controls can be tailored to module-specific issues (e.g., a tilted module install can be corrected by module-specific pressing element controls, etc.), and individual faulty modules and/or components thereof can be identified more easily, enabling easy maintenance without a need to replace an entire press. In an example, module-specific controls can help prevent lateral material flow and/or egress from the sides of the press by selectively controlling the height between upper and/or lower platens 340 (e.g., by controlling dextral pressing elements 320 differentially from sinistral pressing elements 320, etc.; e.g., example shown in FIG. 25).

However, further advantages can be provided by the system and method disclosed herein.

### 3. System

The system (e.g., the press) functions to apply a continuous pressure and/or heat to a moving composite board material to form a composite board. The system can be 30,000 kg, 50,000 kg, 70,000 kg, 100,000 kg, 200,000 kg, within an open or closed range bounded by any of the aforementioned values, and/or within any other suitable range. The system is preferably a continuous press but can additionally or alternatively be a daylight press, a single-opening press, a membrane press, a cold press, a short-cycle press, and/or any other suitable press type.

In variants, the system can include a top conveyor system 200 and a bottom conveyor system 200 mounted to a press frame 100; a set of core units 300 each including a core unit frame 310, platen 340, pressing element 320, lifting element 330, heating element 600, and/or mating feature; a set of pressure control systems; a power source; and/or other components.

In examples, the system facilitates horizontal motion of the composite board material; however the system can facilitate motion of the composite board material in any other suitable direction and/or can operate on static composite board material. Horizontality is preferably defined relative to the ground but can additionally be defined relative to a gravity vector and/or based on another reference point. Alternatively, the system can move the composite board material along a longitudinal axis of the system (e.g., of the press frame, the belt, etc.) and/or in any other direction.

The system preferably defines a longitudinal axis (e.g., along a length of the press). The longitudinal axis can be the direction of travel of belts 210 of the conveyor systems 200, the axis connecting the infeed and/or outfeed, an axis parallel with the longest non-diagonal dimension of the press, and/or any other suitable axis. In examples, the longitudinal axis can be horizontal or substantially horizontal (e.g., with a slope relative to a horizontal axis of 0.5%, 1%, 2%, 5%, a slope within an open or closed range bounded by any of the aforementioned values, and/or any other suitable slope). However, the longitudinal axis can be otherwise defined.

The system preferably defines a lateral axis (e.g., along a width of the press). The lateral axis can be the cross-belt axis or transverse axis of the conveyor belt 210, can be an axis parallel with the smallest non-diagonal dimension of the press, and/or an axis perpendicular to the longitudinal axis, and/or any other suitable axis. In examples, the longitudinal axis can be horizontal or substantially horizontal (e.g., with a slope relative to a horizontal axis of 0.5%, 1%, 2%, 5%, a slope within an open or closed range bounded by any of the aforementioned values, and/or any other suitable slope). However, the lateral axis can be otherwise defined.

The system preferably defines a vertical axis (e.g., along a height of the press). The vertical axis can be the gravitational axis, an axis perpendicular to the ground, an axis perpendicular to the longitudinal and/or lateral axes, an axis perpendicular to the a lateral plane, and/or any other suitable axis. However, the vertical axis can be otherwise defined.

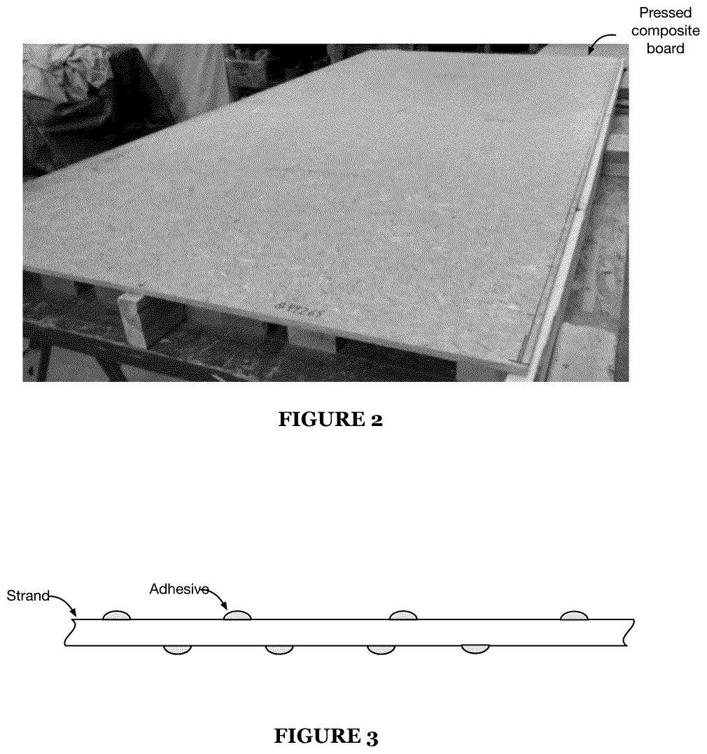

The composite board (e.g., example shown in FIG. 2) can function to withstand stressors on a building structure (e.g., wind, rain, pressure from building components, etc.). The system preferably creates a continuous composite board and cuts the board to the proper length after formation (e.g., lengthwise and/or widthwise). The composite board can be created by compressing a mat of composite board material the board can include 1 layer, 2 layers, 5 layers, 10 layers, 25 layers, 50 layers, 100 layers, 200 layers, 300 layers, 400 layers, 600 layers and/or any other suitable number of layers per cross-sectional inch. The composite board (e.g., the output of the press, etc.) can be any suitable width, length, and/or thickness. The composite board can have a length (e.g., along the longitudinal axis of the press, etc.) and/or width (e.g., along the lateral axis of the press, etc.) of 1 foot, 2 feet, 4 feet, 6 feet, 8 feet, 12 feet, 16 feet, 32 feet, a length and/or width within an open or closed range bounded by the aforementioned values, and/or any other suitable length and/or width. The composite board can have a thickness of ¼ inch, ⅜ inch, 7/16 inch, ½ inch, 9/16 inch, ⅝ inch, ¾ inch, ⅞ inch, 15/16 inch, 1 inch, 1.5 inches, 2 inches, 4 inches, 6 inches, 10 inches, a thickness within an open or closed range bounded by the aforementioned values, and/or any other suitable thickness. The composite board can have a thickness which is a fraction of the thickness of the pre-pressed mat of material (e.g., the composite board material mat ingested by the press). The fraction can be 1%, 2%, 3%, 5%, 8%, 10%, 15%, 30%, 50%, 70%, 80%, 90%, 95%, 99%, 100%, a fraction within an open or closed range bounded by the aforementioned values, and/or any other suitable fraction. However, the shape of the composite board can be otherwise defined.

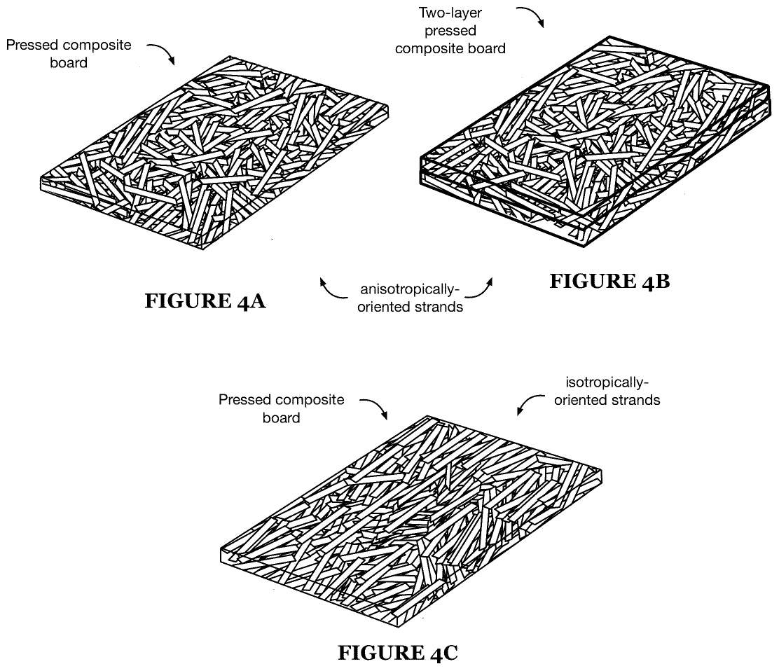

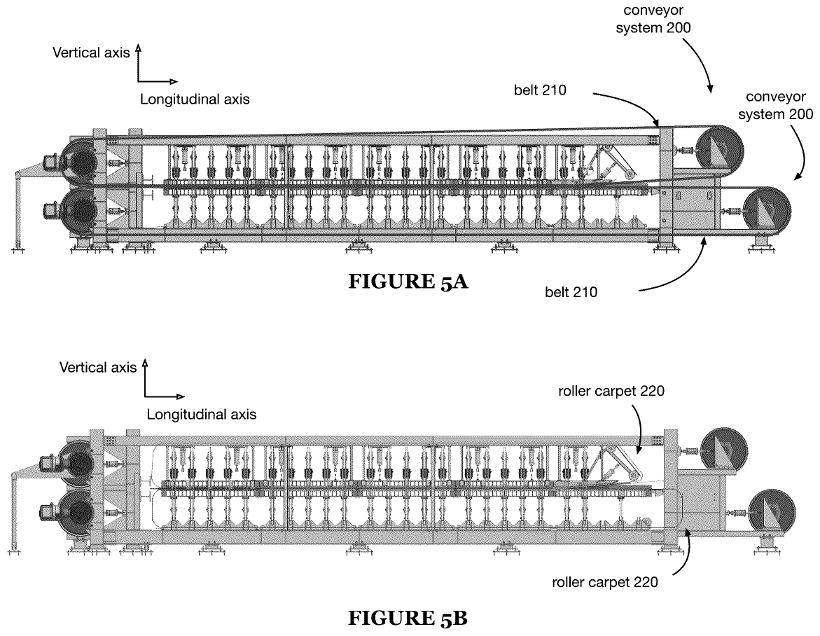

The composite board can include organic materials (e.g., grass, wood, bamboo, corn, sugarcane, reeds, etc.) and/or inorganic materials (e.g., plastics, rubber, plaster, cement, metal, etc.). In variants where the composite board contains plant material, the plant material can include any part of a plant (e.g., leaves, shoots, bark, wood, stems, branches, etc.). The plant materials can have any suitable cross-sectional shape (e.g., round, flat, etc.). Composite board materials can be preprocessed (e.g., stranded, sharded, chipped, pulped, cut, ground-up, ripped, etc.) before forming into the composite board. The composite board can be wholly made up of one material, multiple materials, layers of other composite boards, and/or other arrangements of materials. The composite board material can include an adhesive material (e.g., example shown in FIG. 3). Composite board materials can be oriented isotropically (e.g., example shown in FIG. 4C), anisotropically (e.g., example shown in FIG. 4A and FIG. 4B), in a structured orientation (e.g., a grid and/or hexagon), in alternating directions between isotropic layers, and/or in any other suitable orientation. Additionally or alternatively, the composite board can be and/or have attributes of the building material described in U.S. application Ser. No. 18/339,798 filed 22 Jun. 2023, incorporated herein in its entirety by this reference. Additionally or alternatively, the composite board can be and/or have attributes of the building material described in U.S. application Ser. No. 18/918,560 filed 17 Oct. 2024, incorporated herein in its entirety by this reference. In a specific example, the composite board is 4 ft×8 ft× 7/16″. However, the composite board can be otherwise defined.

In a specific example, the composite board can be made from strands, shavings, chips, strips, and/or other forms of Giant Reed (e.g., Arundo Donax). Giant reed strand mats can be particularly difficult for conventional presses to manage, due to the giant reed strand mat's low bulk density and/or high mat loft, which can be substantially different from wood strand mats (e.g., several times lower bulk density than wood strand mats, several times higher mat loft than wood strand mats). In variants, this system can accommodate the high mat loft and/or low bulk density by leveraging a modular system (e.g., to flexibly adjust the infeed and mat loft reduction length), having offset upper and lower conveyor belt start points, and/or otherwise accommodating the mat loft and/or low bulk density.

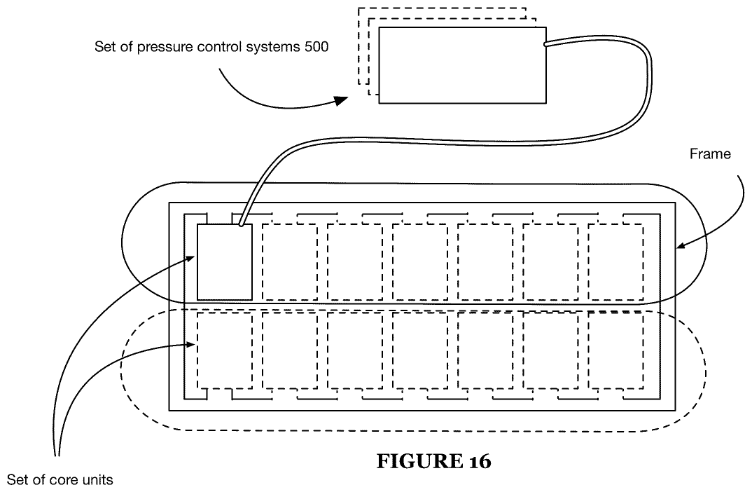

In variants, the system can include an infeed section, core section, and outfeed section (e.g., example shown in FIG. 1). The infeed section can be the side of the press in which the composite board material is inserted. The core section can be the middle portion of the press in which the composite board material is compressed and/or heated to form the continuous composite board. The outfeed section can be the side of the press that egresses the continuous composite board. However, the press can include any other suitable sections. The composite board material can move along the longitudinal axis (e.g., along a lengthwise axis toward the outfeed or toward the infeed) and/or in any other suitable direction. In operation, the system can be connected to a former at the infeed, a finisher and/or trimmer at the outfeed, and/or any suitable piece of equipment. An example of a variant of a composite board manufacturing process is illustrated in FIG. 15. The system is preferably electrically powered (e.g., at 120V, 340V, 480V; using AC power DC, power, 3-phase power, etc.) but can additionally or alternatively be powered through another suitable means. The system can apply pressure to an uncompressed mat of composite board material, a partially-compressed mat of composite board material (e.g., received from another press, etc.), multiple compressed mats (e.g., being laminated together, etc.), and/or a composite board material mat in another suitable state. The system preferably operates continuously, but can alternatively operate between a pressing phase, a transport phase, and/or any other suitable phases.

The press frame 100 can function to retain system components and provide stability during system operation. The press frame 100 can include components made of iron, steel, aluminum, concrete, and/or any other suitable material. The press frame 100 can be modular (e.g., wherein parts are removably connected) or can be a fixed size (e.g., where parts are non-removably connected). The press frame 100 can include one or multiple core units 300. In a first variant, the press frame 100 is a fixed size and supports multiple core units 300. In a second variant, the press frame 100 itself is made of core unit frames 310 (e.g., fixed together, etc.). In a third variant, the press frame 100 includes multiple sub-frames each supporting multiple core units 300, wherein the sub-frames are fixedly connected to each other (e.g., cooperatively forming the press frame 100) However, the press frame 100 and/or core units 300 can have any other suitable arrangement.

The press frame 100 can include a set of motion damping features and/or a set of vibration damping features (e.g., dampers, shocks, etc.). The press frame 100 can include a set of foot elements connecting the press frame 100 to the floor. In a first example, the press frame 100 rests on top of the floor (e.g., via a coincident foot connection). In a second example, the press frame 100 is fixed to the floor (e.g., via a set of removable or nonremovable floor connections; for example, bolts). In a third example, the press frame 100 is integrated into the floor. The foot elements can have a fixed or adjustable height (e.g., via a screw, jack, hydraulic piston, etc.). However, the foot elements can be otherwise configured.

However, the press frame 100 can be otherwise configured.

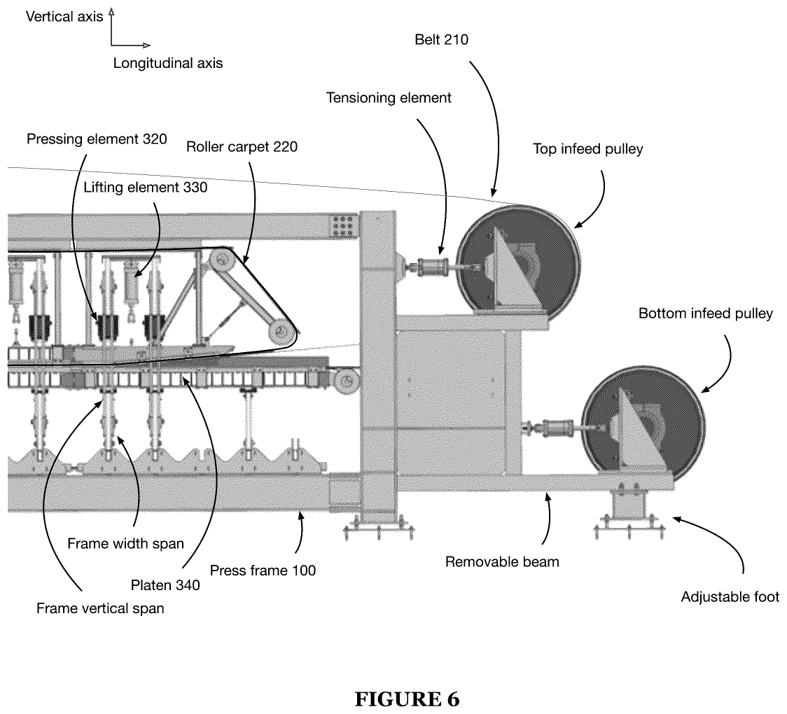

The conveyor systems 200 can function to transport the composite board material through the press (e.g., from the infeed side through the core to the outfeed side) (e.g., example shown in FIG. 5A). The conveyor systems 200 can each include a belt 210, roller carpet 220, protection element 230, pulleys, tensioning elements, release agent applicator, and/or any other suitable elements. A conveyor system 200 preferably surrounds a set of core units 300 (e.g., along the core unit set length), but can additionally or alternatively sit on top of or below the core units 300 or be otherwise arranged. The system can include a top conveyor system 200 and/or a bottom conveyor system 200 that cooperatively define a board compression zone therebetween. The board compression zone can: have substantially the same height between the infeed and the outfeed, monotonically decreasing height (e.g., thickness) from the infeed to the outfeed, monotonically increasing height from the infeed to the outfeed, variable height between the infeed and outfeed, and/or any other suitable height. In an example, the board compression zone has a trapezoidal prism shape (and/or another suitable decreasing-height shape) at the infeed end of the board compressing zone and a rectangular prisms shape in the core and outfeed ends. The system can include one conveyor system 200 on top of the board compression zone and one conveyor system 200 below the board compression zone, one conveyor system 200 below the board compression zone and a static surface above the board compression zone, two static surfaces (e.g., temporarily-static conveyors, platens 340, etc.) above and below the board compression zone, respectively, and/or any other suitable number and arrangement of conveyor systems 200. In variants with one conveyor system 200 on each side of the board compression zone, the conveyor systems 200 can move a belt 210 at the same speed or different speeds. In a specific example, the conveyor system 200 speed is 8 feet/minute. Each conveyor system 200 is preferably thermally conductive but can alternatively be thermally insulative. The conveyor systems 200 preferably have the same belt speeds as each other but can alternatively have different belt speeds. Examples of conveyor system belt speeds include 5 ft/minute 8 ft/minute, 10 ft/minute, 20 ft/minute, 40 ft/minute, 60 ft/minute, 90 ft/minute, 120 ft/minute, a belt speed within an open or closed range bounded by the aforementioned values, and/or any other suitable belt speed. The conveyor systems 200 are preferably parallel to the longitudinal axis (e.g., horizontal), but can alternatively be angled relative to the longitudinal axis. The conveyor systems 200 are preferably straight (e.g., do not rotate composite board material about the vertical axis) but can additionally or alternatively be curved. The conveyor systems 200 preferably extend (e.g., transport composite board material) in a direction parallel with the longitudinal axis but can additionally or alternatively extend in any other suitable direction.

The belt 210 functions to apply friction to the composite board material to facilitate composite board material motion through the board compression zone of the press. The system preferably includes a belt 210 above the board compression zone and a belt 210 below the board compression zone (e.g., an top and bottom belt 210, each a part of an top conveyor system 200 and a bottom conveyor system 200, respectively), but can additionally or alternatively include a single belt 210 (e.g., upper belt 210, lower belt 210, etc.) multiple belts 210 per conveyor system 200, no belt 210 for one or both conveyor systems 200, and/or any other suitable number and/or arrangement of belts 210. The belt 210 can be steel, aluminum, carbon fiber, rubber, polyurethane, and/or any other suitable material or set of materials. The belt 210 preferably extends along a longitudinal axis of the system but can additionally or alternatively extend along any other suitable axis of the system. The belt preferably has a loop shape (e.g., a conveyor loop, etc.) but can additionally or alternatively have another suitable shape. The belt 210 can include a measurement feature for speed tracking, slippage tracking, and/or other forms of sensing. The measurement feature can be a painted pattern, notches along the edge of the belt 210, and/or any other suitable measurement feature. The belt 210 preferably interfaces with a release agent applicator at the outer face of the belt 210 on the infeed side of the conveyor system 200 but can alternatively interface with the release agent applicator at any other suitable position. The belt 210 can be a sheet of belt material welded together to form a loop but can alternatively be otherwise formed.

The belt 210 can be suspended from the pulleys and/or belt supports (e.g., attached to the press frame 100 and/or core unit 300). The belt outer surface preferably contacts the composite board material but can alternatively contact any other suitable system component. The belt inner surface preferably contacts a roller carpet 220 but can alternatively contact a protection element 230, platen 340, any other suitable system component, and/or no other system component. The belt 210 can be in tension from pulleys but can alternatively be relaxed. In an example, the belt 210 is installed in a relaxed state and then tensioned due to motion of the pulleys driven by the tensioning elements. The belt 210 can be tensioned (e.g., the pulleys can be moved) from the infeed side and/or outfeed side. The belt 210 can be in the same or differential amounts of tension along the width of the belt 210 (e.g., to correct widthwise slippage). Preferably, the top belt 210 (e.g., belt 210 of the top conveyor system 200) is shorter than the bottom belt 210 (e.g., the belt 210 of the bottom conveyor system 200), which can, in variants, enable maintenance access to the bottom belt 210 without a maintenance well. The belt 210 can include a measurement feature for speed tracking, slippage tracking, and/or other forms of sensing. The measurement feature can be a painted pattern, notches along the edge of the belt 210, and/or any other suitable measurement feature. The belt 210 can preferably interface with a release agent applicator at the outer face of the belt 210 on the infeed side of the conveyor system 200 but can alternatively interface with the release agent applicator at any other suitable position. The belt 210 can preferably interface with a belt lateral displacement sensor at a lateral edge of the belt 210; however, the belt 210 can otherwise interface with or not interface with a belt lateral displacement sensor. In an example, the belt lateral displacement sensor includes a spring in tension (and/or compression, etc.) which applies a lateral normal force to the belt lateral edge. The belt can be installed in any suitable manner. In an example, one belt 210 (e.g., a bottom belt 210) can be installed first, then welded at the top outer face of the belt 210, then the other belt 210 (e.g., a top belt 210) can be installed second, then welded at the top outer face of the belt 210 (e.g., the top of the press). However, the belt 210 can be otherwise configured. In another example, nonexclusive with the first, the bottom belt can be installed by removing a removable beam of the press frame, installing the belt, then re-attaching the removable beam (e.g., example shown in FIG. 6, etc.).

The roller carpet 220 (e.g., example, shown in FIG. 5B) can function to provide a rolling connection between the belt 210 and a static surface (e.g., a protection element 230, a platen 340, a force element, etc.). The roller carpet 220 can be a roller chain but can alternatively be another rolling material. The roller carpet 220 can preferably be thermally conductive but can alternatively be thermally insulative. The roller carpet 220 can have a loop shape but can alternatively have another suitable shape. The roller carpet 220 can separate from the belt 210 (e.g., at the outfeed and/or the infeed) but can alternatively be in continuous contact with the belt 210. The roller carpet 220 preferably translates (e.g., rotates around the conveyor system, etc.) but can alternatively not rotate. In variants where the roller carpet 220 rotates, the roller carpet 220 is preferably passively translated by the belt 210 (and/or any other suitable system component, etc.) but can alternatively be motorized. In a specific example, the roller carpet 220 is supported on its inner surface by a set of rollers at the infeed side and the outfeed side of the conveyor system 200 (e.g., example shown in FIG. 17B); a protection element 230 attached to the platens 340; and static or rolling elements on the top of the press. The roller carpet length can be the same or different between conveyor systems 200. The roller carpet length can be adjusted (e.g., by adding “rollers”, etc.) or can be fixed. The roller carpet 220 position can be tracked or not tracked. The roller carpet 220 can be configured to be replaceable without replacing the belt 210 but can alternatively be otherwise configured. However, the roller carpet 220 can be otherwise configured.

The protection element 230 can function to prevent wear of the roller carpet 220, belt 210 and/or platens 340, and can optionally transfer force from the pressing elements 320 to the roller carpet 220, belt 210, platens 340, and/or another component. In a specific example, the protection element 230 is a sheet of metal statically mounted to the platens 340 within a conveyor system 200 between the platens 340 and the roller carpet 220, wherein the protection element 230 functions to protect the platen 340 from wear and tear due to lengthwise roller carpet motion across the platen 340. The protection element 230 is preferably steel but can alternatively be another suitable material (e.g., steel, plastic, aluminum, etc.). The system can include one protection element 230 per roller belt 210, one protection element 230 per core unit 300, one protection element 230 for each platen 340, and/or any other suitable number of protection elements 230. The protection element 230 can extend between multiple platens 340 (e.g., preferably all top platens 340 or all bottom platens 340 in a press, etc.) but can alternatively not extend between platens 340. The protection element 230 can be a sheet, a loop (e.g., welded loop), and/or have any other suitable form factor. The protection element 230 is preferably continuous between connected platens 340 but can additionally or alternatively not be continuous. In variants with multiple protection elements 230, the protection elements 230 can be fixed (e.g., welded) to each other or not fixed to each other. Alternatively, in a variant, the protection elements 230 can overlap such that protection elements 230 attached to platens 340 further from the infeed side are between an edge of a closer protection element 230 and the platen 340 (e.g., the protection elements are imbricated, etc.). The protection element 230 can be removably or non-removably connected to the platens 340. Alternatively, the protection element 230 can be non-connected to the platens 340. However, the protection element 230 can be otherwise configured.

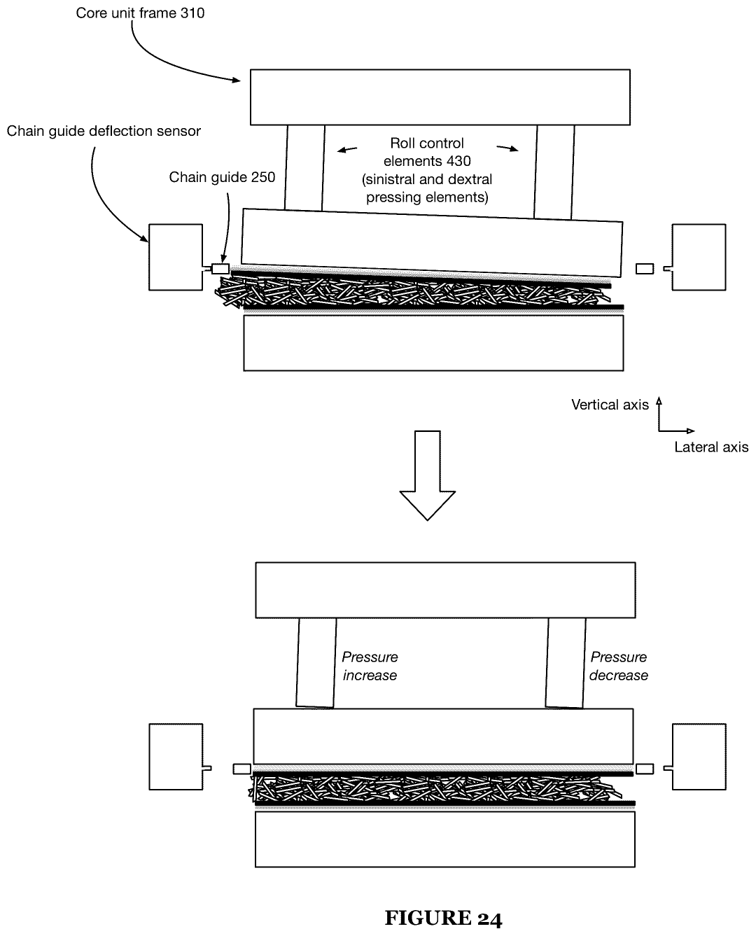

The roller carpet 220 can be laterally constrained with a set of chain guides 250. Chain guides 250 can be on one or both lateral sides of the roller carpet. In an example, chain guides can contact the roller carpet when the roller carpet moves laterally and/or at all times. Chain guides 250 are preferably free to move laterally but can alternatively be laterally static. In an example, a chain guide lateral displacement sensor (e.g., example shown in FIG. 24) measures deflection of a laterally-movable chain guide 250 to identify and/or estimate lateral movement of the roller carpet 220. Chain guides 250 can be biased towards the roller carpet 220 (e.g., with a spring, etc.) or non-biased towards roller carpet 220. However, the set of chain guides 250 can be otherwise configured.

The pulleys (e.g., example shown in FIG. 6) function to put a belt 210 in tension and drive belt translation. The system can include one infeed pulley and/or one outfeed pulley. Alternatively, the system can include multiple pulleys at the infeed and/or outfeed. In a specific example, the infeed pulley for the bottom belt 210 is preferably further in the infeed direction than the infeed pulley for the top belt 210. This arrangement can facilitate easy replacement of belts 210 (e.g., the bottom belt 210 can be welded from above). The pulley axis is preferably adjustable using tensioning elements but can alternatively be fixed. The closest vertical distance between the top and bottom pulley for the infeed and/or outfeed (e.g., the vertical length of the board compression zone) is preferably equal than the composite board thickness but can alternatively be higher than the composite board thickness. The vertical location of the pulley is preferably fixed but can alternatively be adjustable using the tensioning elements. The pulley is preferably connected to tensioning elements but can alternatively or additionally be connected directly to the press frame 100. The pulley is preferably motorized but can alternatively be passive. In a first variant, the infeed and outfeed pulleys are both motorized. In a second variant, the outfeed side is motorized, and the infeed side is passive. In a third variant, no pulleys are motorized (e.g., another element drives motion of the belt 210). However, the pulley can otherwise be powered. The pulley is preferably rolling but can alternatively be static or can include rolling elements arranged circumferentially. However, the pulley can be otherwise configured.

The tensioning elements function to adjust the position of a side of a pulley and provide a tensioning force to the pulley. The system can include one tensioning element at each side of the pulley, multiple tensioning elements on each side of the pulley, one tension element per pulley (e.g., wherein the other widthwise end of the pulley has a non-translating connection to the press frame 100), or any other suitable arrangement of tensioning elements. The tensioning elements preferably move the pulley lengthwise, but can additionally or alternatively move the pulley vertically or sideways (e.g., in a widthwise direction). In an example, the tensioning element can move a side of the pulley linearly lengthwise such that the pulley rotates about a vertical axis. The tensioning element can include a fluid-based or mechanically-based actuation mechanism. In a first variant, wherein the tensioning element is hydraulically and/or pneumatically actuated, a pressure control system pressurizes a hydraulic fluid which drives actuation of a tensioning element (e.g., a piston). In a specific example, a pneumatic pump drives actuation of a hydraulic piston which provides hydraulic pressure to the tensioning element. In a second variant, the tensioning element is mechanically actuated (e.g., the tensioning element is a motorized roller, an electric linear actuator, and/or any other suitable actuation mechanism. However, the actuation mechanism can be any other suitable type of actuation mechanism. The tensioning element preferably controls the force applied by the tensioning element to the pulley but can additionally or alternatively control the position of the pulley and/or pulley side to which the tensioning element is attached. In an example, a pressure sensor fluidly connected to the tensioning element monitors the force applied by the tensioning element. The tensioning element can be adjusted based on data from tensioning elements (e.g., a pressure sensor within a hose), data from an opposite tensioning element on the same pulley, data from a tensioning element on an opposite pulley (e.g., on the opposing feed side or vertical side), data relating to observed board quality (e.g., surface finish, thickness, etc.), visual data, temperature data, belt tracking data (e.g., lengthwise tracking and/or widthwise tracking), belt age, manually-input preferences, belt type, press temperature, ambient temperature, composite board material state (e.g., lateral sideways flow, lateral position of a boundary of the composite board material, etc.) and/or any other suitable type of information. The tensioning element can adjust tension automatically and/or manually. In a first example, when a belt 210 is slipping to a side, the tensioning element on that side can move outward along the lengthwise axis (e.g., outward relative to the press center) to apply more tension on that side of the belt 210, causing the belt 210 to correct its position by moving towards the opposite widthwise side of the press. Alternatively, in this example, the opposite tensioning element can move inward along the lengthwise axis. Alternatively, both the tensioning element and the opposite tensioning element can move when a widthwise belt slippage is detected. The tensioning elements on the same pulley can apply symmetrical or asymmetrical forces in steady state. The tensioning elements can be controlled by a pressure control system (e.g., a pump) on or off the press and/or an actuator at the pulley and/or tensioning element. However, the tensioning elements can otherwise be controlled. The tensioning elements can provide tension even while the press is off (e.g., using stored pressurized air which pressurizes a hydraulic reservoir connected to a hydraulically-actuated tensioning element). In an example, the tensioning elements can provide tension even when a hydraulic pump on the pressure control system is not pumping. Alternatively, the tensioning element can provide tension and/or change (e.g., increase or decrease) the amount of applied tension only when the system is connected to power. However, the tensioning element can be otherwise configured.

The optional release agent applicator can function to apply a release agent to the outer face of a belt 210 (e.g., example shown in FIG. 12). The release agent applicator can be on the top and/or bottom belt 210. The release agent applicator is preferably at the infeed but can alternatively be at the outfeed end of a belt 210. The release agent applicator preferably applies the release agent before the composite board material is introduced to the system. The release agent can be silicone-based, petroleum-based, wax-based, plant-based, and/or made of another suitable type of material. The release agent applicator can include a roller, sprayer, brush, and/or another application component. The release agent applicator can optionally include a release agent removing element (e.g., for removing the last cycle of release agent). However, the release agent can be otherwise configured.

However, the conveyor system 200 can be otherwise configured.

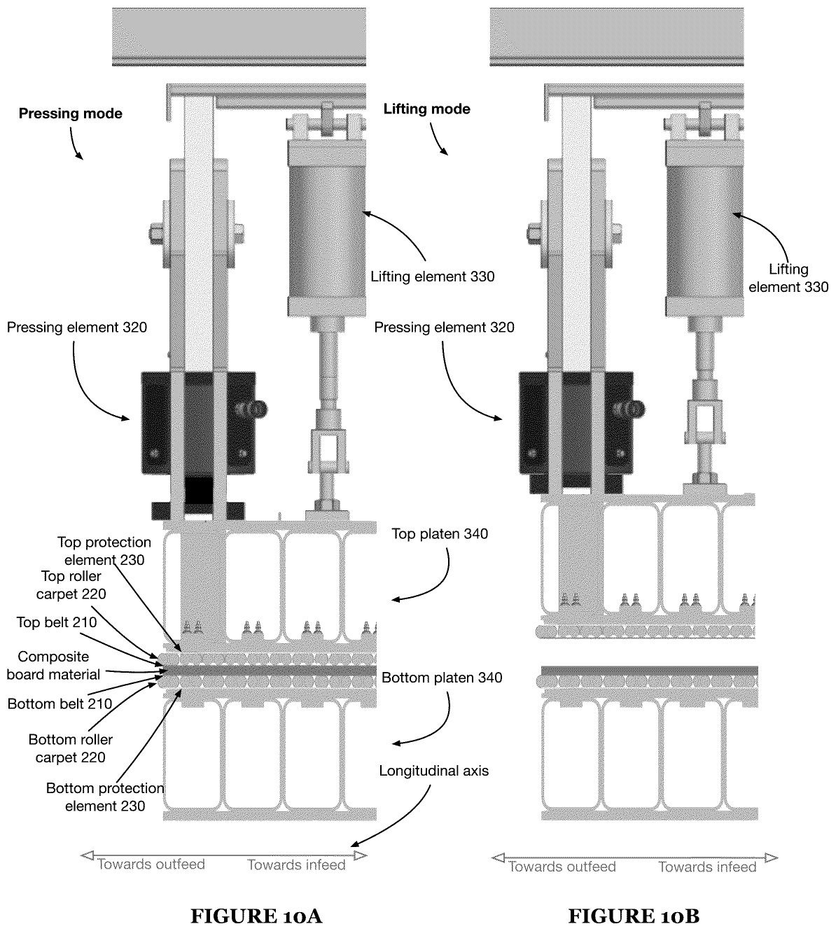

The set of core units 300 of the system function to provide pressure and/or heat to a portion of composite board material as it moves through the system. The set of core units 300 can include multiple core units 300 or one core unit 300. Each core unit 300 can be modular and can be added or removed from the system in order to increase or decrease the length of the press. Additionally or alternatively, the core units 300 can be swapped out of the press for maintenance and/or inspection due to being removably mounted to the press. The core units 300 can be connected to each other and/or the frame by fixed or removable connections. The system can include a set of core segments, which can each include a top core unit 300 and a bottom core unit 300 (e.g., example shown in FIG. 9A), or be otherwise constructed. The set of core units 300 can include a set of top core units 300 (e.g., mounted within the loop of the top conveyor system belt 210) and a set of bottom core units 300 (e.g., mounted within the loop of the bottom conveyor system belt 210). In an example, a top core unit 300 and a bottom core unit 300 can share the same frame. The set of core units 300 can include at least one core unit 300 mounted to the press frame 100, each other, the floor, and/or any other system component. Lengthwise, the set of core units 300 can apply a constant pressure (e.g., the same pressure proximal the infeed as proximal the outfeed), increasing pressure, and/or pressure according to any other lengthwise pressure profile. Widthwise, the set of core units 300 can apply a constant pressure, a higher pressure near the lengthwise center axis, a lower pressure near the lengthwise center axis, and or pressure according to any other suitable widthwise pressure profile. Each core unit 300 can apply a temporally static or dynamic (e.g., sinusoidal, increasing, decreasing, etc.) pressure. The set of core units 300 can collectively or individually perform other actions to the composite board material (e.g., coating, vibration, hydrating, photographing, etc.).

Each core unit 300 within the set of core units 300 can function to provide pressure and/or heat to a portion of the composite board material. Each core unit 300 can include a pair of platens 340, a set of core unit frames 310, a set of optional pressing elements 320, a set of optional lifting elements 330, a set of optional heating elements 600 and/or any other suitable system components. In a specific example, a top core unit 300 is within the top belt 210 and includes a top platen 340, a set of pressing elements 320, and a set of lifting elements 330; and a bottom core unit 300 is within the bottom belt 210 and includes a bottom platen 340. In this example, the top core unit 300 and bottom core unit 300 cooperatively form a core segment. For each core segment, the system can include a set of core unit frames 310 physically connecting each top core unit 300 to a bottom core unit 300; however, the top core units 300 and bottom core units 300 can be otherwise connected.

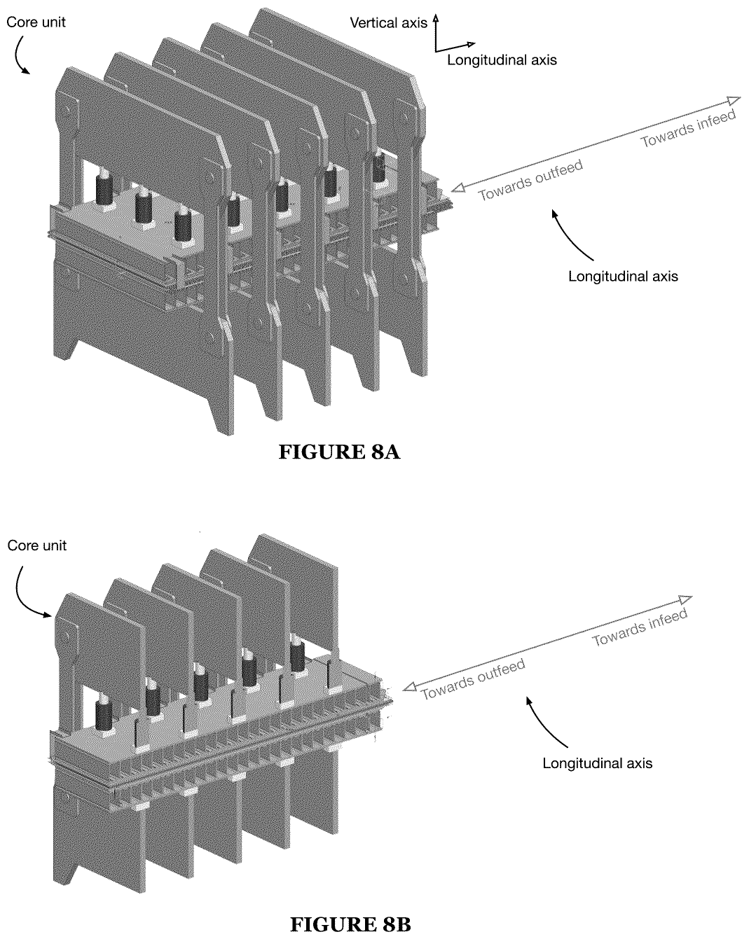

The platen 340 (e.g., example shown in FIG. 7A) can function to distribute pressure across a flat surface onto the top or bottom of the composite board material via the protection element 230 and/or roller carpet 220. Each core unit 300 preferably includes one platen 340 but can alternatively include multiple platens 340. The platen 340 can be a bottom platen 340 (e.g., for bottom core units 300) or a top platen 340 (e.g., for top core units 300; example shown in FIG. 9B). Each platen 340 is preferably connected to a set of core unit frames 310 via a fixed connection (e.g., preferably the bottom platen 340 is connected via a fixed connection) or a moving connection (e.g., preferably the top platen 340 is connected via a moving connection). The platen structure can be a solid plate or an assembly. In an example, the platen 340 includes a set of parallel rectangular beams with a top plate and a bottom plate. However, the platen structure can be otherwise configured. Each platen 340 can additionally include a monitoring feature which is observed by a sensor on or off the core unit 300 to determine platen vertical, lengthwise, and/or widthwise location and/or alignment with other platens 340. Each platen's longitudinal motion, lateral motion, vertical motion and/or roll (e.g., rotation about a longitudinal axis) can be constrained or not constrained. Examples of platen longitudinal motion constraints can include other platens 340 (e.g., via fixed or contact connections between serial platens 340), longitudinal alignment elements 410, lifting elements 330, pressing elements 320, and/or other components. Examples of platen lateral motion constraints include other platens 340, lateral alignment elements 420, lifting elements 330, pressing elements 320, core unit frame 310, press frame 100, and/or any other suitable component. Examples of platen roll constraints include other platens 340, pressing and lifting elements 330 (e.g., using dynamic active control), platen roll control elements 430, and/or any other suitable component. Examples of platen vertical motion constraints include the pressing and lifting elements 330, other platens 340, lateral alignment elements 420, core unit frame 310, press frame 100, spacers between platens 340, and/or any other suitable vertical motion constraint.

Each platen 340 can be static or can move in the vertical direction. In a first variant, a platen 340 can be attached to the core unit frame 310 via a static connection. In a second variant, a platen 340 can be attached to a core unit frame 310 via a dynamic connection (e.g., a pressing element 320, lifting element 330, etc.). In an example, a top platen 340 in a top core unit 300 has a dynamic connection to the core unit frame 310 and/or press frame 100; and a bottom platen 340 in a bottom core unit 300 has a static connection to the core unit frame 310 and/or press frame 100. In examples, pressing elements 320 and lifting elements 330 at sinistral and dextral sides of a platen 340 can differentially control the dextral and sinistral heights of the platen 340.

Each platen 340 can include a mating feature which functions to facilitate removable connections between adjacent core units' platens 340 (e.g., example shown in FIG. 7B). The mating feature can be located on each or one longitudinal side (e.g., parallel to the lateral direction) of a platen 340. The mating feature can be removable from and/or fixed to the platen 340. The mating feature is preferably rigid but can alternatively be non-rigid (e.g., elastic, actuating, etc.). The mating feature can be a set of plates configured to interlock with plates on a platen 340 on an adjacent core unit 300, but the mating feature can alternatively be any other suitable feature. However, the platen 340 can be otherwise configured.

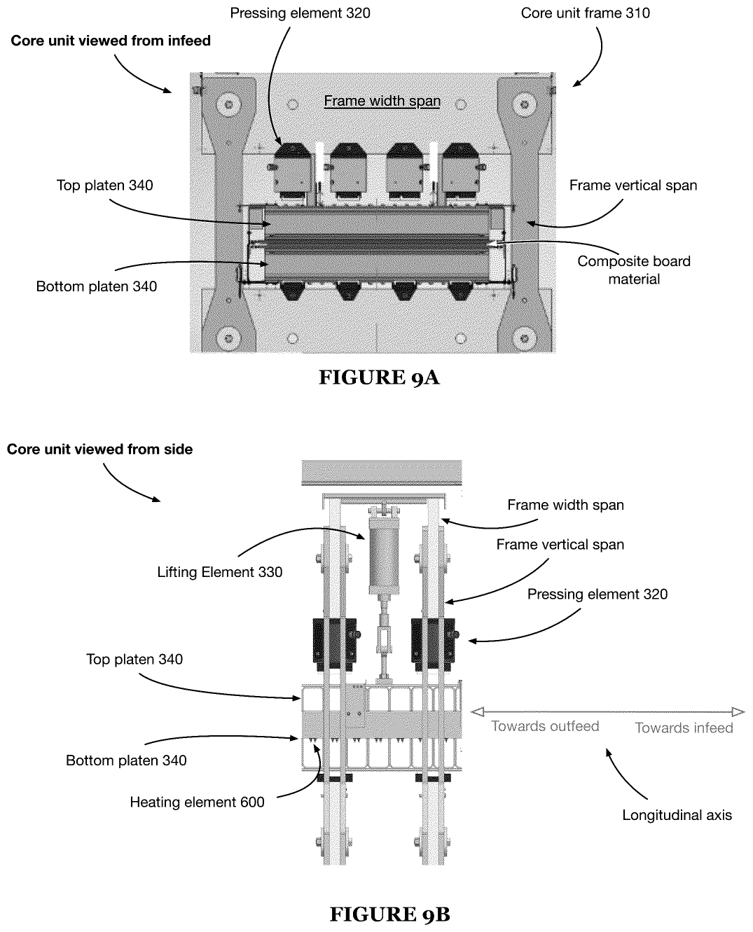

The core unit frame 310 can function to support components of the core unit 300, physically connect the core unit 300 to an opposing core unit 300. The core unit 300 can be connected to one core unit frame 310 and/or multiple core unit frames 310 in series (e.g., examples shown in FIG. 8A and FIG. 8B). Each core unit frame 310 can include a set of frame width spans and a set of frame vertical spans. The frame width spans can be beams spanning part of the width of the press and/or in any other suitable orientation. The frame vertical spans can function to connect the frame width spans of opposing core units 300 to each other via a rigid connection. The frame vertical spans can be in tension to counteract the pressure between opposing platens 340 by the pressing elements 320. However, the frame vertical spans can be otherwise configured. However, the core unit frame 310 can be otherwise configured.

The optional pressing elements 320 function to apply a pressure to the platen 340. A pressing element 320 can apply pressure by increasing in length, thus moving the platen 340 away from the frame width span connected to the pressing element 320. The pressing element 320 preferably applies a vertical pressure only but can additionally or alternatively apply a horizontal pressure (e.g., lengthwise and/or widthwise). The pressing element 320 is preferably attached to a top platen 340 but can alternatively or additionally be attached to a bottom platen 340. In a specific example, the pressing element 320 can be attached to a top face of the top platen 340 (e.g., opposite the board compression region). The pressing element 320 is preferably attached to the top core unit frame width span, but alternatively can be attached to the bottom core unit frame width span. The core unit 300 can include multiple pressing elements 320 per core unit frame 310 (e.g., aligned widthwise, lengthwise, etc.), one pressing element 320 per core unit frame 310, multiple pressing elements 320 per core unit 300, one pressing element 320 per core unit 300, and/or any other suitable number of pressing elements 320. Pressing elements 320 are preferably hydraulic cylinders (e.g., fluidly connected to a pump on the pressure control system) but can alternatively be pneumatic cylinders, electric linear actuators, screw jacks, a chain hoist, a mechanical leverage system, and/or any other suitable type of pressing element 320. In a specific example, the pressing elements 320 can be controlled by the actuation of valves on a pressing cart (e.g., a pressure control system). In this specific example, each pressing element 320 can be controlled individually or in combination with other pressing elements 320 (e.g., other dextral/lateral pressing elements 320, etc.).

The pressing elements 320 can preferably control the platens 340 to a predetermined height (e.g., relative to the bottom platen 340, core unit frame 310, etc.), but can additionally or alternatively pressurize to a predetermined pressure, apply force until a force threshold is met, and/or can otherwise be controlled. The pressing elements 320 which are latitudinally dextral (e.g., right) and latitudinally sinistral (e.g., left) are preferably differentially controlled but can alternatively be uniformly controlled (e.g., controlled together). In an example, when lateral misalignment of a top and bottom platen is detected (e.g., detected by vertical and/or lateral measurements of the composite board material, vertical and/or horizontal displacement of a top platen 340, top roller carpet 220, chain guide 250, belt 210, etc.), the pressing elements 320 on the one lateral side are controlled to apply more pressure to the platen 340 than the pressing elements 320 of the other lateral side. In another example, the system detects composite board material egress out the side of the board compression zone, and dynamically controls the left and right pressing elements 320 to reduce material side egress. Pressing elements 320 are preferably controlled based on sensor measurements specific to the core unit 300 of which they are a part but can additionally or alternatively be controlled based on measurements captured at other core units 300. However, the pressing elements 320 can be otherwise configured.

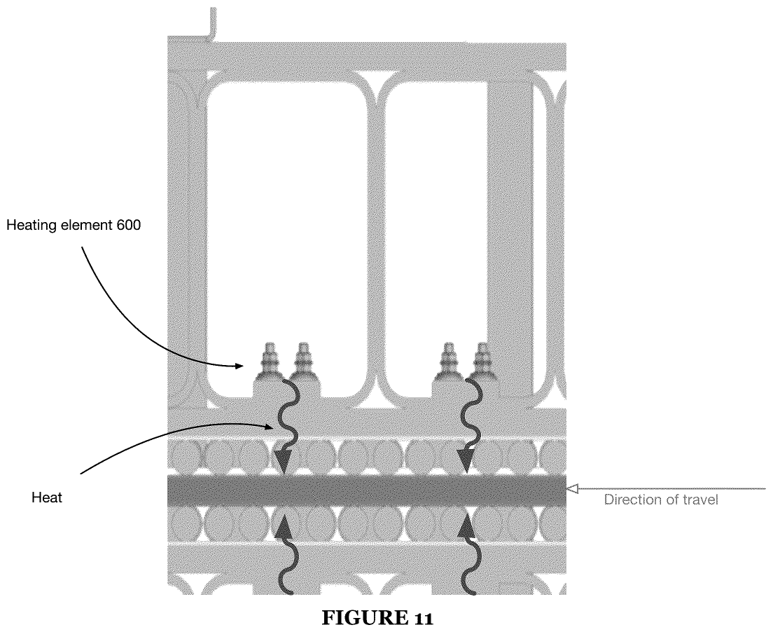

The optional lifting elements 330 can function to move a platen 340 away from the board compression zone (e.g., to facilitate addition of composite board material, for conveyor system maintenance, etc.) by applying a separation force to the platen 340. In a variant, the lifting element 330 also functions as a pressing element 320. The lifting elements 330 can be manually or automatically controlled. The controls for the lifting element 330 can be integrated with the controls for the pressing element 320 but can alternatively be independent of the controls for the pressing element 320. In an example, when the pressing element pressure decreases, the lifting element 330 applies a separation force to the top platen 340. The lifting element 330 can be connected to a pressure control system via the same or different fluid connection as the pressing element 320. In a specific example, the separation force applied by the lifting element 330 is less than the pressing force applied by the pressing element 320. In a specific example, the core unit 300 can operate between a pressing mode and a lifting mode (e.g., example shown in FIG. 10A and FIG. 10B). However, the lifting element 330 can be otherwise configured.

The heating elements 600 can function to provide heat to the composite board material as it travels through the system. Each heating element 600 can be thermally connected to the platen 340 and/or any other suitable element. The heating element 600 can be mounted to the platen 340 (e.g., inner platen face, outer platen face, etc.), roller carpet 220, and/or another component. The heating elements 600 can be evenly spaced widthwise and/or lengthwise (e.g., in a rectangular grid, hexagonal grid, etc.). Alternatively, the heating elements 600 can be irregularly spaced. The heating element 600 can be a resistive heating element 600, induction heating element 600, steam heating element 600, and/or any other suitable type of heating element 600. Heating elements 600 can be ceramic, copper, and/or another suitable material. The heating element 600 can include sensors (e.g., a thermocouple, IR sensors, a thermistor, etc.) or not include sensors. The heating elements 600 can be set to specific target temperatures but can alternatively vary in temperature over time and/or based on position.

Different heating elements 600 can be operated at different target temperatures. In a first variant, laterally outward heating elements 600 can have a lower or higher target temperature than laterally inward heating elements 600. In a second variant, heating elements 600 proximal and/or distal the outfeed can have higher or lower target temperatures than heating elements 600 longitudinally proximal to the middle of the press. Alternatively, all heating elements 600 can have the same target temperature. In an example heating elements 600 can be controlled to heat each platen 340 to a temperature determined according to a predetermined longitudinal and/or lateral temperature profile. However, differences in heating element 600 target temperatures can be otherwise characterized.

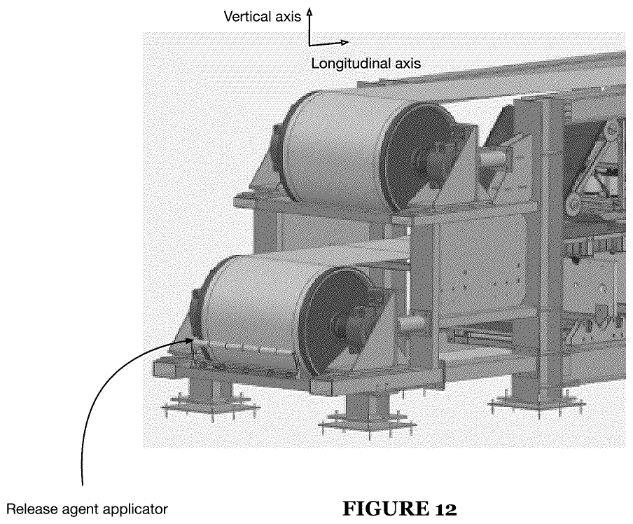

Heating elements 600 can be electrically powered, passively powered (e.g., facilitating heat transfer from a heated fluid, and/or can be otherwise powered. Heating elements 600 can be constantly heating (e.g., at a static target temperature), providing cyclical heating (e.g., temporally or longitudinally), heating responsive to temperature sensor measurements falling below a predetermined threshold (e.g., determined using a temperature profile, etc.), and/or can heat according to any other pattern. In a specific example, heat travels from the heating elements 600 through the platen 340, protection element 230, roller carpet 220, and belt 210 to the composite board material (e.g., example shown in FIG. 11). However, the heating elements 600 can be otherwise configured.

However, the set of core units 300 can be otherwise configured.

Alignment elements function to control and/or constrain alignment of platens 340 and/or other system components. Alignment can refer to alignment between platens 340 (e.g., alignment between a top platen 340 and a vertically-offset opposing bottom platen 340), alignment between a platen 340 and a core unit frame 310 and/or press frame 100, alignment of a belt 210 with the platens and/or press frame 100, and/or alignment of any other suitable components with each other. Preferably, alignment elements constrain platen motion relative to the press frame 100, relative to an opposing platen, relative to an adjacent platen, relative to a core unit frame 310, and/or any other suitable relationship.

Alignment elements can connect to any of: a top platen 340, a bottom platen 340, a core unit frame 310, a press frame 100, and/or any other suitable system component via fully constrained connections and/or partially-constrained connections. Examples of fully constrained connections include welded connections, bolts, and/or other suitable fully constrained connections. Examples of partially-constrained connections can include contact connections (e.g., unilateral contact connections), elastic connections, pin/revolute connections, track/prismatic joint connections, ball-and-socket connections, slider-crank connections, universal joint connections, cylindrical joint connections, cam/follower connections, rack/pinion connections, hinge connections, and/or any other suitable type of partially-constrained connections.

Alignment elements can be passive or active. In an example, an alignment element (e.g., a set of pressing elements 320) is controlled based on per-core unit measurements. Alignment elements can control vertical platen motion, longitudinal platen motion, lateral platen motion, rotational platen motion (e.g., roll about a longitudinal axis, etc.), and/or any other suitable direction of rotation. Alignment elements are preferably metal (e.g., steel, iron, etc.) but can additionally or alternatively include other materials and/or components made of other materials.

In a first variant, an alignment element is a longitudinal alignment element 410 controlling longitudinal motion. In this variant, the longitudinal alignment element 410 resists longitudinal motion of a top platen 340, bottom platen 340, core unit 300, and/or any other system component relative to an opposing platen 340, other core units 300, the press frame 100, and/or any other suitable system component. In this variant, the longitudinal alignment element 410 preferably connects to the platen 340 directly but can additionally or alternatively connect to the platen 340 indirectly (e.g., via a laterally-aligned bar fixed to the platen 340, etc.).

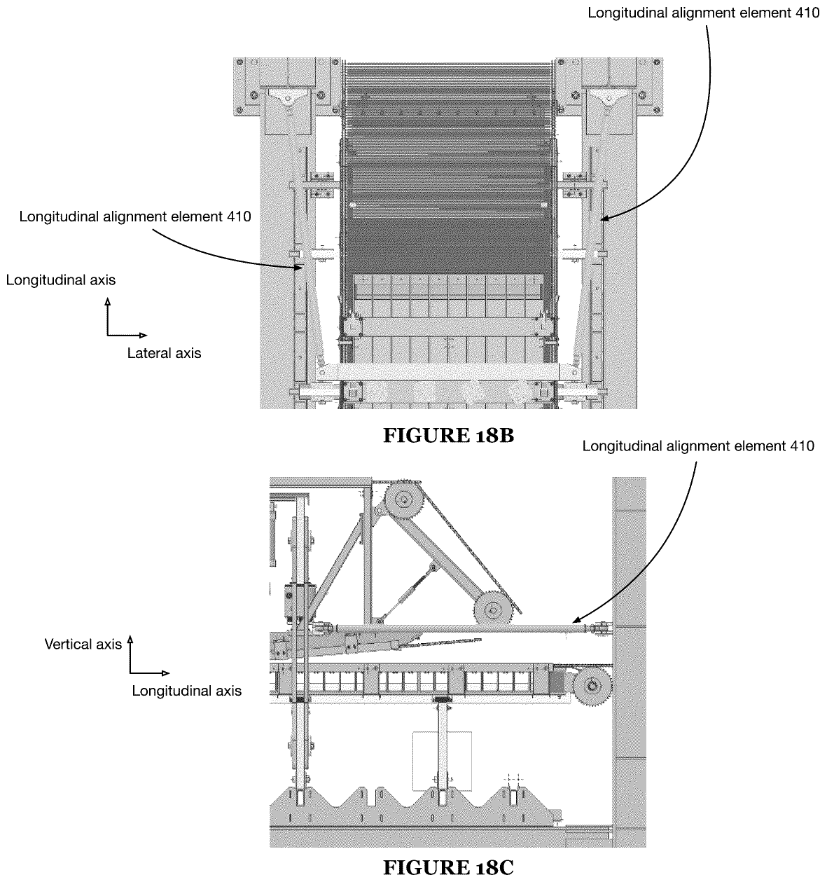

In a first example, the longitudinal alignment element 410 is a longitudinal strut (e.g., examples shown in FIG. 18A and FIG. 18C). The longitudinal strut is preferably in tension during press operation but can alternatively be in compression during press operation. The longitudinal strut preferably attaches to one platen 340 (e.g., a terminal platen in a series of platens) but can alternatively be attached to multiple platens 340. The terminal platen is preferably the platen 340 closest to the infeed but can alternatively be another platen 340 in the series. The longitudinal strut preferably forms a pair with another longitudinal strut but can alternatively be a singular longitudinal strut or can be otherwise numbered. In a first example, a pair of struts each connect a sinistral or dextral side of a platen 340 to a side of the press frame 100 and/or core unit frame 310. In this example, the pair of struts can be parallel to each other or angled relative to each other (e.g., a yaw angle, pitch angle, roll angle, etc.; example shown in FIG. 18B). In a first specific example, the pair of struts form a chevron brace shape with the platen 340 and press frame 100. In a second specific example, the pair of struts are angled inwards (e.g., a yaw rotation) towards the frame central axis. In a second example, a strut connects a lateral center of a longitudinal edge of a terminal platen to the press frame 100. Preferably, the struts are symmetrical across a sagittal plane of the press, but the struts can alternatively not be parallel.

Each longitudinal strut preferably extends along the length of the press frame 100 (e.g., along the longitudinal axis); however, longitudinal struts can alternatively extend along any other suitable axis. Each longitudinal strut can have a center axis pointing within 1 degree of the longitudinal axis, 5 degrees, 10 degrees, 20 degrees, within an open or closed range bounded by any of the aforementioned values, and/or any other suitable degree relative to the longitudinal axis. In variants, each longitudinal strut can have a minor vertical and/or lateral geometric component. In examples, the longitudinal struts can be horizontal and/or substantially horizontal (e.g., within 5 degrees, 2 degrees, 1 degree, 0.5 degrees, 0.1 degree, an angle within an open or closed range bounded by the aforementioned values, and/or any other suitable angle). Alternatively, the longitudinal struts can be angled relative to a lateral plane (e.g., 30 degrees, 60 degrees, etc.).

In a second example, the longitudinal alignment element 410 is a longitudinal cordage (e.g., cables, wires, a chain, etc.). In this example, the longitudinal cordage can have any of the characteristics of the longitudinal strut of the second example.

In a third example, the longitudinal alignment element 410 is a longitudinal bracket (e.g., a bracket connecting the platen 340 to the press frame 100 and/or an opposing platen 340. In this example, the longitudinal bracket is preferably at the outfeed but can alternatively be at the infeed.

However, longitudinal alignment elements 410 can be otherwise characterized.

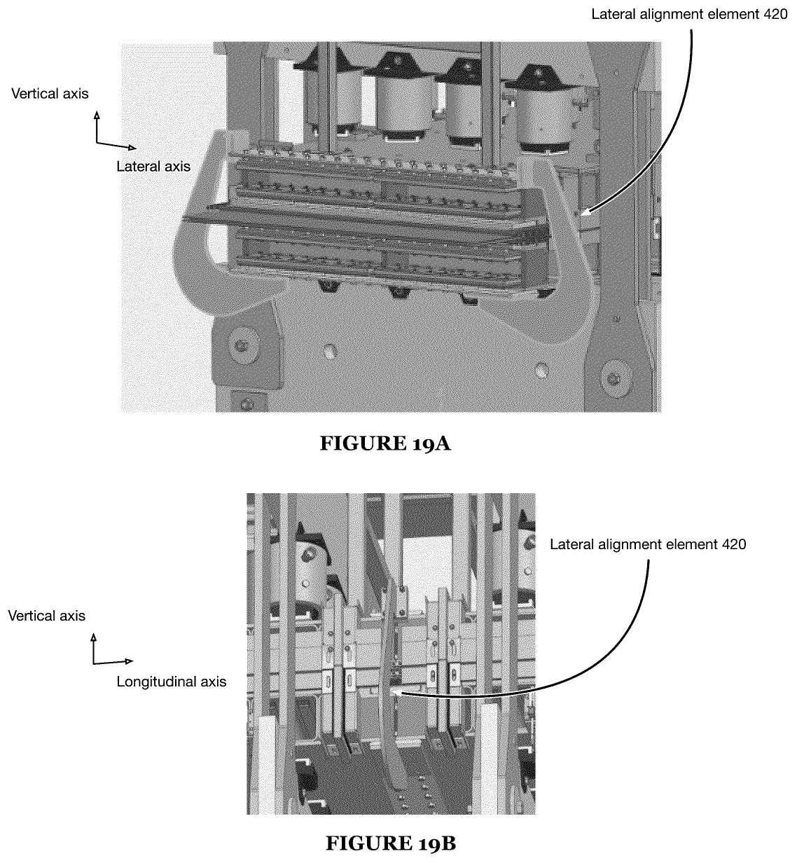

In a second variant, an alignment element is a lateral alignment element 420 controlling lateral motion (e.g., examples shown in FIG. 19A and FIG. 19B). In this variant, the lateral alignment element 420 resists lateral motion of a platen 340 relative to another platen 340, relative to a core unit frame 310, relative to a press frame 100, and/or another suitable system component. In this variant, the lateral alignment element 420 preferably has one fully-constrained connection and one partially-constrained connection (e.g., enabling vertical platen motion), In a first example, the lateral alignment element 420 has a fully constrained connection to a first platen 340 (e.g., a top or bottom platen 340) and a partially constrained connection to a second platen 340 (e.g., an opposite bottom or top platen 340 relative to the first platen 340). In a specific example, the lateral alignment element 420 is bolted to the bottom platen 340 and touches a laterally outward side of the top platen 340. In this variant, the lateral alignment element 420 is preferably directly opposite another alignment element, but the lateral alignment element 420 can alternatively be longitudinally offset from the opposite lateral alignment element 420 or can have no opposite lateral alignment element 420. In this variant, the lateral alignment element 420 is preferably on both lateral sides of the platen 340 but can alternatively be on one lateral side of the platen 340.

In a first example of this variant, the lateral alignment element 420 is a platen bracket. In this example, the platen bracket can connect the platen 340 relative to an opposite platen, the core unit frame 310, the press frame 100, and/or another suitable system component. The platen bracket is preferably c shaped but can alternatively be L shaped and/or any other suitable shape. The platen bracket is preferably rigidly mounted (e.g., fully constrained, etc.) to a bottom face and/or lateral side face of a bottom platen 340, a top face and/or lateral side face of a top platen 340, the core unit frame 310, the press frame 100, and/or any other suitable system component; however the platen bracket can be otherwise rigidly mounted. The platen bracket is non-rigidly mounted (e.g., partially constrained) to a side face of a top or bottom platen 340 (e.g., an opposite platen 340 to the platen 340 to which the bracket is rigidly mounted, etc.) In this example, the partially-constrained connection is a bumper (e.g., a rubber bumper, plastic bumper, etc.) which slides along a lateral side of the platen 340.

In a second example of this variant, the lateral alignment element 420 is a track. The track can link a platen 340 to another platen 340 and/or a core unit frame 310 but can alternatively link any other system components. The track can be rigidly mounted to the frame in one or multiple positions; alternatively, the track can be rigidly mounted to a platen 340 or another system component. The track can constrain motion of a connected platen 340 to which it is not rigidly mounted (e.g., a platen 340 with a track engagement feature; for example, a wheel assembly, etc.).

In a third example of this variant, the lateral alignment element 420 is a set of actively-controlled actuators which push and/or pull the platen laterally responsive to sensor data indicating lateral platen displacement. The actuator can link the platen 340 to the core unit frame 310 and/or the press frame 100. The actuator can be or include any type or variant of active motion control which is able to be performed by the aforementioned “pressing element 320” or “lifting element 330. In a specific example, the actively-controlled actuator is a horizontal lateral hydraulic cylinder applying a lateral force on a platen 340 (e.g., on the side of a platen 340, on a bracket on a top or bottom face of the platen 340, etc.).

However, lateral alignment elements 420 can be otherwise characterized.

In a third variant, the alignment element is a roll control element 430, which functions to control the relative height of laterally-opposite platen sides.

In a first example of this variant, the roll control element 430 is the set of pressing and/or lifting elements 330 applying differential vertical forces. The differential vertical forces can be calculated based on an estimated platen roll. In a first specific example, sensor measurements can be measurements from displacement sensors sensing lateral displacement of laterally-opposite parts of a side of a platen 340 (e.g., top of top platen 340). In this specific example, the displacement sensor can measure vertical platen displacement relative to a core unit frame 310, the press frame 100, and/or another suitable reference component. In a second specific example, sensor measurements can be measurements of the composite board exiting the press (e.g., measuring differential height along lateral length of board). In a third specific example, the sensor measurements can be measurements of lateral flow of composite board material (e.g., composite board material being forced out of the sides of the press, etc.) between platens 340, as measured by an optical sensor, a depth sensor, and/or any other suitable sensor. In a fourth specific example, sensor measurements can be measurements from displacement sensors measuring displacement of laterally-opposite sides of a platen 340 (e.g., example shown in FIG. 25).

In a second example of this variant, the roll control element 430 is a set of hard stops applying vertical force to one or both lateral halves of the platen 340. The hard stops can be rigid spacers attached to the platen 340, rigid brackets attached to the core unit frame 310 and/or press frame 100, and/or any other suitable hard stop. The hard stop can apply force to a face of the board proximal the composite board material or distal the composite board material.

However, roll control elements 430 can be otherwise characterized.

However, the system can include any other suitable type of alignment elements.

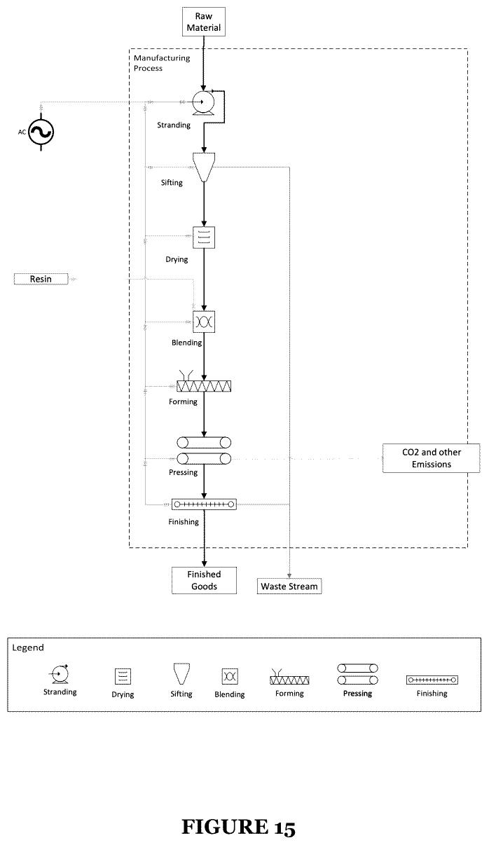

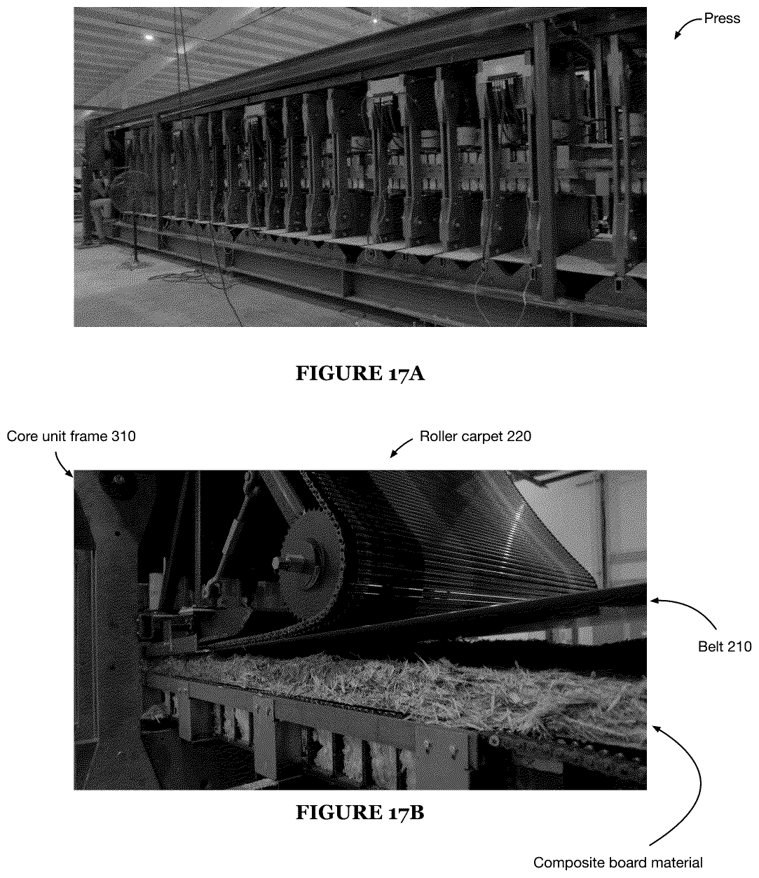

The pressure control systems 500 function to pressurize fluid for controlling pneumatic and/or hydraulic pumps (e.g., example shown in FIG. 16). The pressure control systems 500 can control the tensioning elements, pressing elements 320, lifting elements 330, and/or any other pressure controlled element. The pressure control systems 500 can be fluidly connected to the pressure-controlled elements or can be otherwise connected. The pressure control systems 500 can be connected to a pressure-controlled element via a hose or another type of connection. The pressure control system 500 can optionally include a cart (e.g., example shown in FIG. 13). Pressure control systems 500 can be mounted to the press frame 100, can be mounted to a core unit frame 310, and/or can be mounted at another suitable location. The system can include one pressure control system 500 per core unit 300, per core segment, per lifting element 330, per pressing element 320, per pulley, per lengthwise side (e.g., infeed, outfeed, etc.), and/or any other suitable allocation of pressure control systems 500. Types of pressure control systems include hydraulic systems (e.g., where a pump constantly operates to maintain hydraulic pressure; example shown in FIG. 14A), pneumatic systems, and/or combinations of pneumatic and hydraulic systems. In an example, a pressurized air reservoir generated by a pneumatic pump applies a mechanical force to a pneumatic cylinder mechanically coupled to a hydraulic piston (e.g., cooperatively forming a pneumatically-driven hydraulic pump; example shown in FIG. 14B). Thus, the pressure control system 500 can maintain a constant hydraulic pressure without constant power. However, the pressure control system 500 can be any other suitable type of system. The pressure control system 500 can be automatically or manually controlled. For pressing elements 320, controls can be based on the top platen vertical location, target board thickness, measured board thickness, measured board density, the lengthwise position of a platen 340, pressing element current pressure, pressing element target pressure, belt tension, and/or any other suitable piece of information. For tensioning elements, controls can be based on widthwise belt location, lengthwise belt speed, pulley angle (e.g., about a vertical axis), belt tension (e.g., widthwise belt differential tension), belt material, belt age, belt temperature, and/or any other suitable piece of information. For lifting elements 330, controls can be based on the pressing element pressure, lifting element 330 pressure, top platen height, system operation state (e.g., “loading,” “heating up,” etc.), and/or any other suitable piece of information. In an example, the pressure control system 500 is a pressing cart supporting a hydraulic pump configured to fluidly connect to pressing elements 320 on a core unit 300 via a set of hoses. In a second example, the pressure control system 500 is a lifting cart supporting a pneumatic pump configured to fluidly connect to lifting elements 330 on a core unit 300 via a set of hoses. In a third example, the pressure control system 500 is a set of tensioning element carts supporting a hydraulic pump and/or a pneumatic pump and air reservoir configured to connect to a pair of tensioning elements via a set of hoses. However, the pressure control systems 500 can be otherwise configured.

The system can include one or more power sources that function to power all or a subset of the system components (e.g., conveyor systems 200, core units 300, pressure control systems, etc.). The power source is preferably an electrical power source but can additionally or alternatively be a steam power source and/or any other suitable power source. The electrical power source can be: outlet power (e.g., grid power, wall outlet power, 2-phase power, 3-phase power, etc.), battery power, and/or any other suitable electrical power source. In examples, the system can be 480V, 340V, 120V, and/or operate on any other suitable voltage.

The system can include sensor subsystems which function to capture information about the system. Sensors can be per-core unit 300, per-lateral side of a core unit 300, per-core segment, per-press, and/or can otherwise correspond to components of the press. Sensors can measure the composite mat material, pressing elements 320, platens 340, and/or any other suitable system component. In a variant, sensors can be communicatively connected to the processing system and can transmit measurements in real time.

In a first variant, a sensor subsystem is a displacement sensor which functions to capture information about relative position and/or rotation of system components. Displacement sensors can be vision-based, mechanical (e.g., a linear potentiometer, etc.), and/or can have any other suitable modality. Examples of displacement sensors include LVDT, linear potentiometers, laser sensors (e.g., distance sensors, light curtains, etc.), capacitive sensors, linear encoders, rotary encoders, visual code trackers (e.g., IR tag trackers, QR tag trackers, etc.), and/or any other suitable type of displacement sensors.

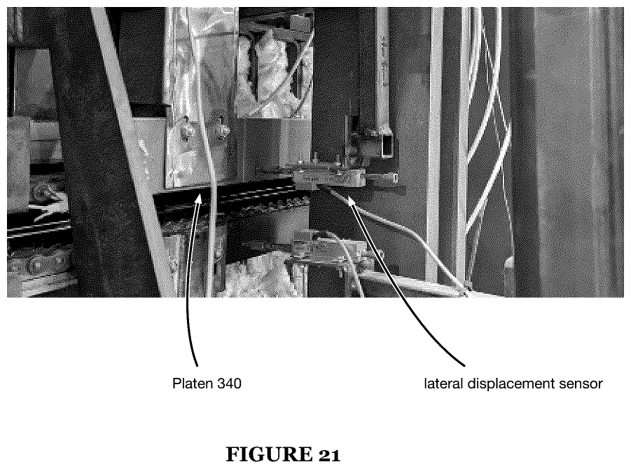

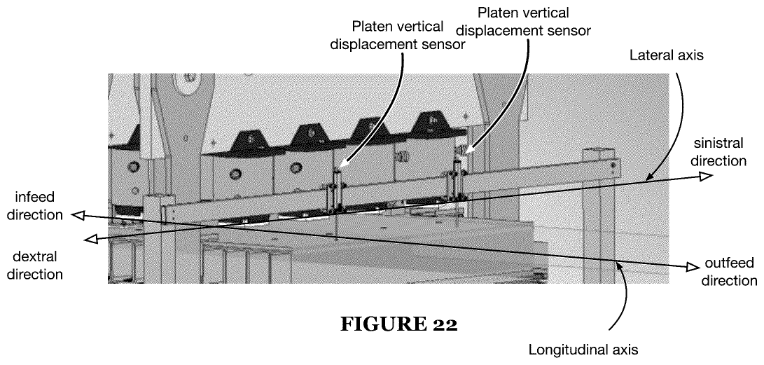

In a first example, displacement sensors can measure vertical displacement of a platen surface and/or portion thereof relative to a press frame 100, core unit frame 310, other platen 340, and/or any other system component (e.g., example shown in FIG. 22). In a second example, displacement sensors can measure lateral displacement (e.g., deflection, etc.) of a platen edge, roller carpet 220, chain guide 250, belt 210, and/or another suitable component relative to the press frame 100, core unit frame 310, other platen 340, and/or any other system component (e.g., example shown in FIG. 21). Such sensors can measure platen displacement directly and/or can measure displacement of the roller carpet, belt, and/or any other suitable system component. In a third example, displacement sensors can measure vertical displacement of platens 340 relative to an opposing platen 340. In a variant, a core unit 300 of the system can include multiple displacement sensors arranged along a lateral axis, each measuring a height of a platen 340. In a specific example, when a first lateral side of the platen 340 is higher than a second lateral side, pressure on pressing elements 320 of the first lateral side is increased relative to pressure on pressing elements 320 of the second lateral side.

In a second example, lateral flow sensors can measure lateral flow of the composite board material as it is pressed. Lateral flow sensors can be cameras (e.g., determining lateral flow based on optical measurements of the composite board material; arranged along a left or right side of a platen and facing upwards or downwards), can be depth sensors (e.g., monitoring the left or right edge of the core unit and measuring a distance of the composite board material from the lateral edge of the platen 340, etc.), and/or any other suitable type of sensor. Lateral flow sensors can be oriented laterally (e.g., pointing horizontally inward toward the centerline of the press, etc.), vertically (e.g., at a lateral boundary of the platen 340, etc.), and/or can be otherwise oriented. In a specific example, when lateral flow of composite board material at a first lateral side meets a condition (e.g., is higher than lateral flow at the other side, is higher than a threshold speed/displacement, etc.), pressure on pressing elements 320 of the first lateral side is increased relative to pressure on pressing elements 320 of the second lateral side. In a second specific example, the left/right differential pressure is dynamically adjusted when board material egress out the sides of the core unit is detected.

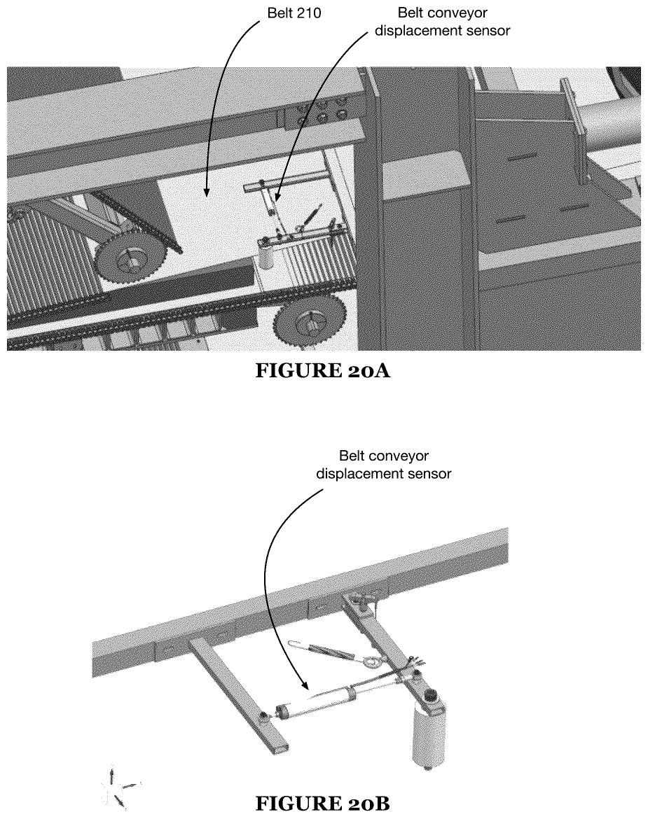

In a third example, belt conveyor displacement sensors arranged at the infeed and/or outfeed can measure lateral motion of the belt 210. Belt conveyor displacement sensors are preferably biased displacement sensors (e.g., example shown in FIG. 20A and FIG. 20B), but can alternatively be any other suitable type of sensor. In a specific example, when a belt conveyor displacement sensor observes lateral motion of the conveyor towards a first lateral side, the tensioning element can increase relative tension on the first lateral side to halt or reverse lateral motion of the conveyor belt 210.

In a fourth example, temperature sensors can measure the temperature of the composite board material (e.g., in the board compression zone), the composite board, and/or the platen 340. Examples of temperature sensors can include electrical temperature sensors (e.g., thermocouples, RTDs, Thermistors, etc.), mechanical temperature sensors (e.g., bimetallic strips, etc.), optical sensors (e.g., infrared sensors, pyrometers, thermal imaging sensors, etc.), and/or any other suitable temperature sensor. In a specific example, when temperature sensors capture measurements that indicate that a platen 340 is below a target setpoint, heating elements 600 can increase applied power to the platen 340.

However, sensor subsystems can be alternatively configured.

The processing system functions to control the overall system and/or system components (e.g., pressing elements 320, lifting elements 330, sensors, press frame 100, adjustable foot elements, tensioning elements, pulleys, pressure control system, etc.) or subcomponents thereof (e.g., motors, valves, etc.) to apply pressure to platens 340 to compress moving material within a board compression zone during circulating motion of the conveyor belts 210; The processing system can control each core unit 300 individually (e.g., independent of other core units 300), each core segment individually, and/or core units 300 and/or segments in combination with other core units 300 and/or core segments).

However, the system can be otherwise configured.

Alternative embodiments implement the above methods and/or processing modules in non-transitory computer-readable media, storing computer-readable instructions that, when executed by the processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUS, TPUS, microprocessors, or ASICs, but the instructions can alternatively or additionally be executed by any suitable dedicated hardware device. All references cited herein are incorporated by reference in their entirety, except to the extent that the incorporated material is inconsistent with the express disclosure herein, in which case the language in this disclosure controls.

Optional elements, which can be included in some variants but not others, are indicated in broken lines in the figures.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

We claim:

1. A modular continuous press, comprising:
a press frame defining a frame length;
an upper and lower conveyor loop mounted to the press frame and extending along the frame length;
a plurality of press modules arranged in series along the frame length, each comprising:
a module frame rigidly mounted to the press frame;
a horizontal lower platen rigidly mounted to the module frame and arranged within the lower conveyor loop;
a horizontal upper platen arranged within the upper conveyor loop;
a bank of vertical hydraulic cylinders, each comprising a left and right hydraulic cylinder subset, statically mounting the horizontal upper platen to the module frame and configured to bias the upper platen toward the lower platen;
a platen alignment bracket statically mounted to the lower platen and applying a lateral alignment force to the upper platen; and
a linear displacement sensor monitoring a vertical position of the upper platen;
wherein upper platens of the plurality of press modules are rigidly connected to each other;
a set of linkages connecting an upper platen of a press module of the plurality of press modules to the press frame, wherein a force applied by the set of linkages opposes a longitudinal friction force applied to the upper platen of the press module by the upper conveyor loop;
a continuous metal layer arranged between the upper conveyor loop and the upper platens of the plurality of press modules; and
a processing system configured to differentially control the left and right hydraulic cylinder subsets of each press module based on the vertical position measured by the respective linear displacement sensor of the respective press module.

2. A modular continuous press system, comprising:
a press frame defining a longitudinal axis;
a pair of vertically-offset conveyor loops movably mounted to the press frame, the pair of conveyor loops arranged along the longitudinal axis and cooperatively defining a pressing region;
a set of press modules, each press module comprising:
a module frame rigidly mounted to the press frame;
a dynamic platen arranged within one of the pair of conveyor loops; and
a set of vertical linear actuators mounting the dynamic platen to the module frame; and
a set of struts connecting the press frame to a dynamic platen from the set of press modules, wherein the set of struts:
extend along the longitudinal axis; and
resist friction forces parallel to the longitudinal axis exerted on the dynamic platen due to motion of the one of the pair of conveyor loops.

3. The modular continuous press system of claim 2, wherein each press module of the set of press modules further comprises:
a base platen opposing the respective dynamic platen across the one of the pair of conveyor loops, the base platen and the respective dynamic platen cooperatively forming a pair of platens; and
a rigid alignment bracket rigidly mounted to one of the pair of platens and applying a lateral alignment force to another of the pair of platens.

4. The modular continuous press system of claim 2, wherein a plurality of dynamic platens of the set of press modules are rigidly fixed to each other.

5. The modular continuous press system of claim 2, wherein the set of struts are angled inward toward a press frame centerline.

6. The modular continuous press system of claim 5, wherein the set of struts are in tension when resisting the friction forces.

7. The modular continuous press system of claim 2, further comprising a processing system configured to independently control a left and right subset of the vertical hydraulic cylinders of a press module of the set of press modules.

8. The modular continuous press system of claim 7, wherein relative differences in control between the right subset and left subset are based on measurements of a composite mat being pressed within the pressing region.

9. The modular continuous press system of claim 2, wherein each press module further comprises electrically-powered heating elements thermally connected to the dynamic platen, and wherein the system further comprises a processing system configured to independently control heating elements of different press modules to different temperatures.

10. The modular continuous press system of claim 2, further comprising a continuous protective layer extending between the dynamic platens of multiple press modules and the one of the pair of conveyor loops.

11. The modular continuous press system of claim 2, further comprising a processing system configured to control the pair of conveyor loops to cooperatively compress a composite mat within the pressing region to a height of less than 10% of a pre-pressed height of the composite mat.

12. The modular continuous press system of claim 2, wherein the one of the pair of conveyor loops is shorter than another of the pair of conveyor loops.

13. A modular press system, comprising:
a press frame defining a longitudinal axis and a lateral axis; and
a set of press modules arranged along the longitudinal axis, each press module comprising:
a module frame rigidly mounted to the press frame;
a pair of platens, comprising a first platen and a second platen mounted to the module frame;
a set of vertical linear actuators mounting the first platen to the module frame; and
a rigid alignment bracket rigidly mounted to one of the first or second platen and exerting a lateral alignment force on the other platen of the pair.

14. The modular press system of claim 13, further comprising a set of longitudinal struts, wherein each longitudinal strut:
links the press frame to a platen of a terminal press module from the set of press modules; and
constrains longitudinal motion of the linked platen.

15. The modular press system of claim 13, wherein the set of longitudinal struts are angled inward toward a centerline of the press frame.

16. The modular press system of claim 13, wherein a plurality of discrete top platens of the set of press modules are rigidly fixed to each other.

17. The modular press system of claim 13, wherein each press module further comprises a set of heating elements controlled independently of heating elements of other press modules.

18. The modular press system of claim 13, further comprising a set of adjustable feet supporting the press frame, and wherein the system weighs over 30000 kg.

19. The modular press system of claim 13, wherein for each press module, the respective set of vertical linear actuators are controlled based on measurements from a set of sensors specific to the respective press module.

20. The modular press system of claim 19, wherein the measurements are of a composite mat being pressed between the pair of platens.
